(19) United States
(12) Patent Application Publication
(10) Pub. No.: US 2026/0251493 A1
(43) Pub. Date: Aug. 27, 2026

(54) POSITION EVALUATION APPARATUS, POSITION EVALUATION METHOD, AND COMPUTER-READABLE MEDIUM

(71) Applicant: NEC Corporation, Minato-ku, Tokyo (JP)

(72) Inventors: Wataru KOHNO, Minato-ku, Tokyo (JP); Reishi KONDO, Minato-ku, Tokyo (JP); Sakiko MISHIMA, Minato-ku, Tokyo (JP); Takashi MATSUSHITA, Minato-ku, Tokyo (JP); Tomoyuki HINO, Minato-ku, Tokyo (JP)

(73) Assignee: NEC Corporation, Minato-ku, Tokyo (JP)

(21) Appl. No.: 18/863,790

(22) PCT Filed: May 25, 2022
(86) PCT No.: PCT/JP2022/021382

§ 371 Date: Nov. 7, 2024

(51) Int. Cl. G01H 9/00; G01M 11/00

(52) U.S. Cl. CPC G01H 9/00; G01M 11/30

(57) ABSTRACT

A position evaluation apparatus (50) according to the present disclosure includes: a vibration characteristic calculation unit (51) configured to input a signal indicating natural vibration occurring at each position of an optical fiber from a sensor and calculate sensing data indicating a vibration characteristic at each position of the optical fiber based on the input signal; a dissimilarity calculation unit (52) configured to calculate dissimilarity in the sensing data between two adjacent points of the optical fiber; and an environment change position estimation unit (53) configured to estimate an environment change position where an environment of the optical fiber changes based on the dissimilarity.

### TECHNICAL FIELD

The present disclosure relates to a position evaluation apparatus, a position evaluation method, and a computer-readable medium.

### BACKGROUND ART

With a technology called optical fiber sensing, it is possible to detect vibration/sound occurring in an arbitrary section on an optical fiber. Specifically, in the optical fiber sensing, an optical fiber sensor inputs coherent pulsed light to the optical fiber, and receives backscattered light of the pulsed light from the optical fiber. At this time, the optical fiber sensor detects a phase difference of the backscattered light occurring between two points on the optical fiber, thereby detecting the vibration/sound applied to the optical fiber in a phase difference evaluation section (gauge length section) which is a section between the two points. Such an optical fiber sensor is implemented by a phase-sensitive optical time domain reflectometer (OTDR), a distributed acoustic sensor (DAS), or the like. Hereinafter, a case where the optical fiber sensor is the DAS will be described.

Meanwhile, an existing communication optical fiber cable including an existing optical fiber may be laid in a portion away from the ground. Examples of such a communication optical fiber cable include an optical fiber cable suspended on poles such as utility poles or steel towers, an optical ground wire (OPGW), and the like.

FIG. 1 illustrates a configuration example of a sensing system using an existing optical fiber suspended on poles arranged in a one-dimensional direction.

In the sensing system illustrated in FIG. 1, the existing optical fiber is suspended on poles 1 to 3, which are utility poles, steel towers, or the like. The DAS is connected to one end of the optical fiber.

The DAS can detect an environment around the optical fiber based on vibration information indicating vibration applied to the optical fiber. Examples of the environment around the optical fiber include wind or rain hitting the optical fiber, the presence or absence of a lightning strike, a vibration mode of the pole, the presence or absence of a living thing, and the like.

In addition, the DAS can detect an abnormality occurring around the optical fiber based on sound information indicating a sound applied to the optical fiber. Examples of the sound caused by the abnormality occurring around the optical fiber include a gunshot sound, an explosive sound, and an abnormal sound caused by an accident.

However, if a laying status of the optical fiber is not considered, there is a possibility that a location where the vibration/sound occurs is erroneously estimated. Examples of the laying status of the optical fiber include an excess length section of the optical fiber resulting from optical fiber fusion work or the like, a suspension section of the optical fiber suspended on the poles, and the like.

FIG. 2 illustrates an example in which a location where vibration occurs is erroneously estimated due to an excess length of the optical fiber.

As illustrated in FIG. 2, position information of the vibration occurrence location measured by the DAS is “a length of the optical fiber from the DAS to a vibration point” (hereinafter, defined as “DAS coordinate”). For example, the DAS can measure the vibration occurrence location on the DAS coordinate based on a time difference between a time when pulsed light is input and a time when backscattered light of the pulsed light is received.

In the example of FIG. 2, the pole 2 includes the excess length section of the optical fiber. Therefore, in a case where vibration occurs at a position farther than the pole 2 in a case where viewed from the DAS, a vibration occurrence location on a distance (hereinafter, defined as “real world coordinate”) from the DAS toward the pole does not coincide with the vibration occurrence location on the DAS coordinate.

Therefore, in the case of constructing the sensing system using the optical fiber suspended on the poles, it is necessary to accurately know an environment change position where the environment of the optical fiber changes as the DAS coordinate. The environment change position of the optical fiber is, for example, a position of each pole on which the optical fiber is suspended, the suspension section of the optical fiber suspended between the poles, the excess length section of the optical fiber, or the like.

An example of a method of matching the real world coordinate with the DAS coordinate is a method of generating an event at a position whose real world coordinate is known, and associating the position on the real world coordinate with the vibration occurrence location or vibration occurrence section measured by the DAS for vibration occurring due to the event.

FIG. 3 illustrates an example of a method of artificially vibrating the pole on which the optical fiber is suspended and matching the real world coordinate and the DAS coordinate.

As illustrated in FIG. 3, in a case where the pole is artificially vibrated, the DAS measures the vibration occurrence section on the DAS coordinate. Then, the position of the pole on the real world coordinate and the vibration occurrence section on the DAS coordinate are made to correspond to each other. In the example of FIG. 3, the excess length section of the optical fiber is present on the vibrated pole. Therefore, the vibration occurrence section on the DAS coordinate corresponds to the excess length section of the optical fiber.

However, the method illustrated in FIG. 3 has the following problems.
It takes a lot of man-hours to investigate each pole.
In a case where the pole is vibrated, the vibration propagates to the optical fiber suspended on both sides of the pole, and thus, the vibration section instantaneously spreads.
This method cannot be applied to a pole (for example, a large pole such as a steel tower) that is difficult to be artificially vibrated.

Therefore, recently, a method of knowing the position of the pole on which the optical fiber is suspended on the DAS coordinate by a method different from the method illustrated in FIG. 3 has also been proposed.

For example, Patent Literature 1 discloses a technology in which a section in which an intensity of vibration detected by optical fiber sensing is equal to or greater than a threshold is determined as a section in which a natural pattern of a utility pole occurs, and a point at which vibration with the maximum intensity occurs in the section is estimated as a position of the utility pole.

### CITATION LIST

### Patent Literature

Patent Literature 1: International Patent Publication No. WO2020/044648

### SUMMARY OF INVENTION

### Technical Problem

As described above, the technology described in Patent Literature 1 focuses on the threshold (that is, a magnitude of the vibration) of the intensity of the vibration, and estimates that the point at which the vibration with the maximum intensity occurs is the position of the utility pole. Therefore, the technology described in Patent Literature 1 cannot estimate a point other than the point at which the vibration with the maximum strength occurs as the position of the utility pole.

Therefore, it is considered that there is still room for improvement in estimation accuracy of the environment change position of the optical fiber such as the position of the pole.

In view of the above problems, an object of the present disclosure is to provide a position evaluation apparatus, a position evaluation method, and a computer-readable medium capable of improving estimation accuracy of an environment change position of an optical fiber.

### Solution to Problem

A position evaluation apparatus according to one aspect includes:
a vibration characteristic calculation unit configured to input a signal indicating natural vibration occurring at each position of an optical fiber from a sensor and calculate sensing data indicating a vibration characteristic at each position of the optical fiber based on the input signal;
a dissimilarity calculation unit configured to calculate dissimilarity in the sensing data between two adjacent points of the optical fiber; and
an environment change position estimation unit configured to estimate an environment change position where an environment of the optical fiber changes based on the dissimilarity.

A position evaluation method according to one aspect is a position evaluation method executed by a position evaluation apparatus, the position evaluation method including:
a vibration characteristic calculation step of inputting a signal indicating natural vibration occurring at each position of an optical fiber from a sensor and calculating sensing data indicating a vibration characteristic at each position of the optical fiber based on the input signal;
a dissimilarity calculation step of calculating dissimilarity in the sensing data between two adjacent points of the optical fiber; and
an environment change position estimation step of estimating an environment change position where an environment of the optical fiber changes based on the dissimilarity.

A computer-readable medium according to one aspect is a non-transitory computer-readable medium storing a program for causing a computer to execute:
a vibration characteristic calculation step of inputting a signal indicating natural vibration occurring at each position of an optical fiber from a sensor and calculating sensing data indicating a vibration characteristic at each position of the optical fiber based on the input signal;
a dissimilarity calculation step of calculating dissimilarity in the sensing data between two adjacent points of the optical fiber; and
an environment change position estimation step of estimating an environment change position where an environment of the optical fiber changes based on the dissimilarity.

### Advantageous Effects of Invention

According to the above-described aspect, it is possible to provide a position evaluation apparatus, a position evaluation method, and a computer-readable medium capable of improving estimation accuracy of an environment change position of an optical fiber.

### BRIEF DESCRIPTION OF DRAWINGS

FIG. 1 is a diagram illustrating a configuration example of a sensing system using an existing optical fiber suspended on poles arranged in a one-dimensional direction.

FIG. 2 is a diagram illustrating an example in which a location where vibration occurs is erroneously estimated due to an excess length of the optical fiber.

FIG. 3 is a diagram illustrating an example of a method of artificially vibrating the pole on which the optical fiber is suspended and matching real world coordinate and distributed acoustic sensor (DAS) coordinate.

FIG. 4 is a diagram illustrating an application example of a position evaluation apparatus according to a first example embodiment.

FIG. 5 is a diagram illustrating a configuration example of the position evaluation apparatus according to the first example embodiment.

FIG. 6 is a diagram illustrating an example of a phase difference signal input as an input signal to a vibration characteristic extraction unit according to the first example embodiment.

FIG. 7 is a flowchart illustrating an example of an operation flow of the vibration characteristic extraction unit according to the first example embodiment.

FIG. 8 is a flowchart illustrating an example of an operation flow of a dissimilarity calculation unit according to the first example embodiment.

FIG. 9 is a flowchart illustrating an example of an operation flow of a pole position calculation unit according to the first example embodiment.

FIG. 10 is a diagram illustrating an example of a method of analyzing dissimilarity by the pole position calculation unit according to the first example embodiment.

FIG. 11 is a diagram illustrating a configuration example of a sensing system assumed in a specific example of an operation of the position evaluation apparatus according to the first example embodiment.

FIG. 12 is a diagram illustrating an example of the dissimilarity obtained in a specific example of the operation of the position evaluation apparatus according to the first example embodiment.

FIG. 13 is a diagram illustrating an application example of a position evaluation apparatus according to a second example embodiment.

FIG. 14 is a diagram illustrating a configuration example of the position evaluation apparatus according to the second example embodiment.

FIG. 15 is a flowchart illustrating an example of an operation flow of a weighted dissimilarity calculation unit according to the second example embodiment.

FIG. 16 is a flowchart illustrating an example of an operation flow of an excess length section calculation unit according to the second example embodiment.

FIG. 17 is a diagram illustrating a configuration example of a sensing system assumed in a specific example of an operation of the position evaluation apparatus according to the second example embodiment.

FIG. 18 is a diagram illustrating an example of a frequency average value, dissimilarity, and weighted dissimilarity of power spectra obtained in a specific example of the operation of the position evaluation apparatus according to the second example embodiment.

FIG. 19 is an enlarged view of an X region illustrated in FIG. 18.

FIG. 20 is a diagram illustrating an application example of a position evaluation apparatus according to a third example embodiment.

FIG. 21 is a diagram illustrating a configuration example of the position evaluation apparatus according to the third example embodiment.

FIG. 22 is a flowchart illustrating an example of an operation flow of a pole position calculation unit according to the third example embodiment.

FIG. 23 is a diagram illustrating an example of an analysis target section determined by the pole position calculation unit according to the third example embodiment.

FIG. 24 is a diagram illustrating an example of a window function configured by the pole position calculation unit according to the third example embodiment.

FIG. 25 is a diagram illustrating an example of a relationship between the window function and dissimilarity in a case where an appropriate offset point is obtained by the pole position calculation unit according to the third example embodiment.

FIG. 26 is a diagram illustrating an application example of a position evaluation apparatus according to a fourth example embodiment.

FIG. 27 is a diagram illustrating a configuration example of the position evaluation apparatus according to the fourth example embodiment.

FIG. 28 is a flowchart illustrating an example of an operation flow of an excess length section calculation unit according to the fourth example embodiment.

FIG. 29 is a flowchart illustrating an example of an operation flow of a pole position calculation unit according to the fourth example embodiment.

FIG. 30 is a diagram illustrating an example of an analysis target section determined by the pole position calculation unit according to the fourth example embodiment.

FIG. 31 is a diagram illustrating an example of cross-correlation between weighted dissimilarity and a window function according to the fourth example embodiment.

FIG. 32 is a diagram illustrating an example of a method of calculating a left excess length by the pole position calculation unit according to the fourth example embodiment.

FIG. 33 is a diagram illustrating a configuration example of a position evaluation apparatus according to a fifth example embodiment.

FIG. 34 is a block diagram illustrating a hardware configuration example of a computer that implements the position evaluation apparatus according to each example embodiment.

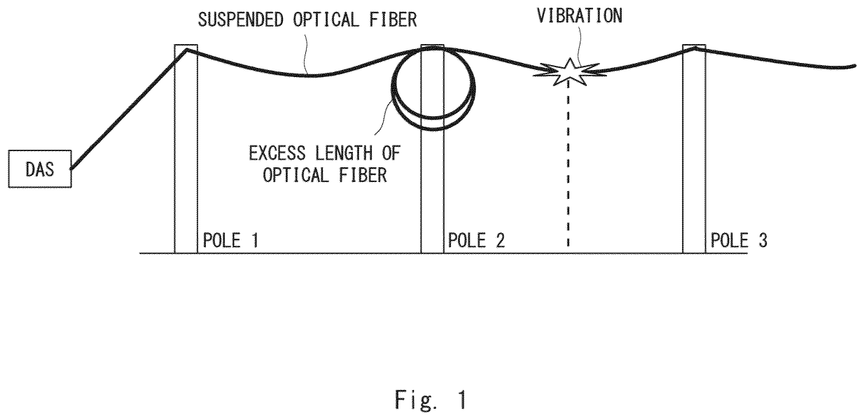

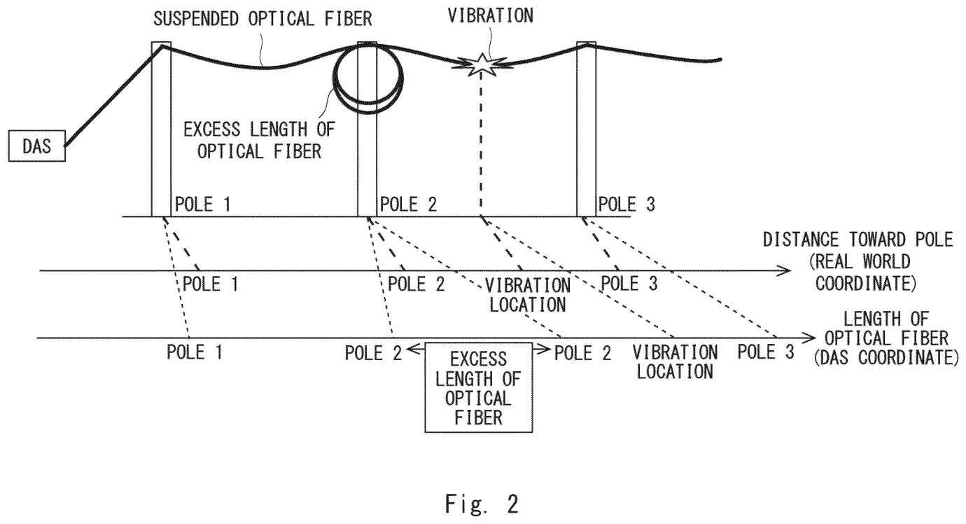

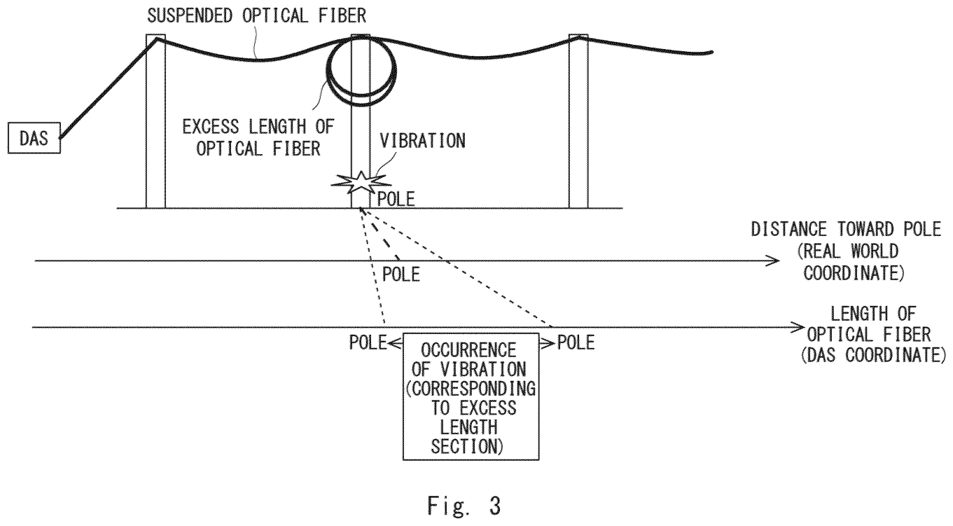

### EXAMPLE EMBODIMENT

Hereinafter, example embodiments of the present disclosure are described with reference to the drawings. Further, the following description and drawings are skipped and simplified as appropriate for clarity of description. Furthermore, in the following drawings, the same elements will be denoted by the same reference signs, and redundant description will be omitted as necessary. In addition, specific numerical values and the like shown below are merely examples for facilitating understanding of the present disclosure, and the present disclosure is not limited thereto.

In each example embodiment of the present disclosure described below, the following (1) and/or (2) is performed.

(1) Estimation of Position of Pole on which Optical Fiber is suspended/Estimation of Suspension Section of Optical Fiber

Specifically, a position of each pole on which an optical fiber is suspended on distributed acoustic sensor (DAS) coordinate is estimated. In addition, a suspension section of the optical fiber suspended between two poles on the DAS coordinate is estimated.

### (2) Estimation of Excess Length Section of Optical Fiber

Specifically, an excess length section of the optical fiber (an optical fiber locally present at a certain location in a real space) on the DAS coordinate is estimated.

Hereinafter, in each example embodiment, a basic idea in performing (1) and/or (2) described above will be described.

(1) Estimation of Position of Pole on which Optical Fiber is suspended/Estimation of Suspension Section of Optical Fiber

Movement of the optical fiber in the suspension section can be regarded as string movement. In each example embodiment, this is used to estimate the suspension section of the optical fiber on the DAS coordinate.
For example, in a case where the total weight of the optical fiber is large, a force for suspending the optical fiber also increases. Therefore, a large tension is always applied to the optical fiber, and dynamic distortion is likely to occur.
The optical fiber is steadily swung by wind.
A transmission speed

$$v = \sqrt{ρ / T}$$

of a signal transmitted through the optical fiber is characterized by a linear density (φ, a tension (T), and a span length (L) of the optical fiber.
The optical fiber is vibrated in a stationary nth-order natural vibration mode (frequency fₙ).

$${f}_{n} = n \sqrt{ρ / T} / 2 L$$

Meanwhile, the position of the pole on which the optical fiber is suspended is a boundary portion between the suspension sections of the optical fiber. In each example embodiment, this is used to estimate the position of the pole on the DAS coordinate.
For example, vibration transmitted through the optical fiber is reflected with the pole as a boundary.
In addition, a vibration characteristic changes for each suspension section with the pole as a boundary.

### (2) Estimation of Excess Length Section of Optical Fiber

In many cases, the excess length section of the optical fiber is bonded or fixed to the pole, and dynamic distortion hardly occurs. Therefore, the excess length section of the optical fiber is insensitive to background noise such as wind and vibration of the pole itself (that is, a noise level is low). In each example embodiment, this is used to estimate the excess length section of the optical fiber on the DAS coordinate.

Hereinafter, each example embodiment of the present disclosure will be described in detail.

### First Example Embodiment

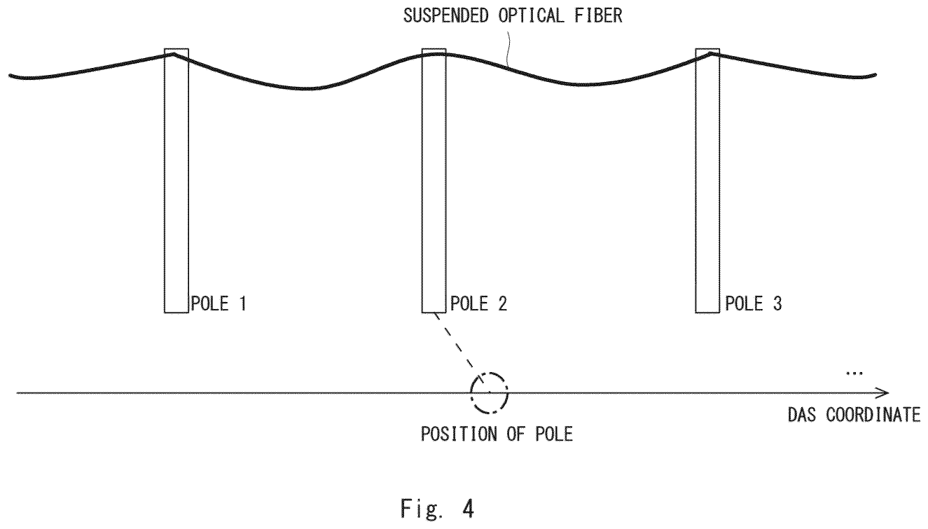

In a first example embodiment, as illustrated in FIG. 4, the position of the pole is estimated and output as a DAS coordinate value.

If the DAS coordinate is redefined, the DAS coordinate is a length of the optical fiber based on a certain point measured by a DAS.

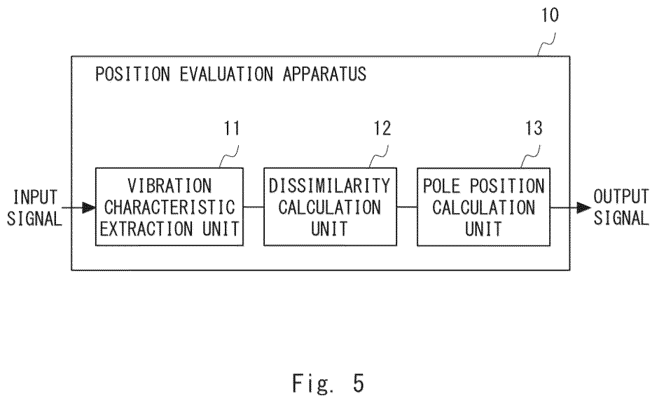

A configuration example of a position evaluation apparatus 10 according to the first example embodiment will be described with reference to FIG. 5.

As illustrated in FIG. 5, the position evaluation apparatus 10 according to the first example embodiment includes a vibration characteristic extraction unit 11, a dissimilarity calculation unit 12, and a pole position calculation unit 13.

The vibration characteristic extraction unit 11 is connected to the DAS (not illustrated), and inputs a phase difference signal of backscattered light obtained from the DAS as an input signal. Then, the vibration characteristic extraction unit 11 extracts an input signal in a certain time section, calculates a power spectrum for the extracted input signal, extracts a power spectrum in a frequency band including a basic vibration mode in the suspension section from the calculated power spectrum, and outputs the power spectrum.

The dissimilarity calculation unit 12 determines an evaluation interval for evaluating dissimilarity. In addition, the dissimilarity calculation unit 12 calculates and outputs dissimilarity between two power spectra at all DAS coordinate points based on the power spectra obtained by the vibration characteristic extraction unit 11.

The pole position calculation unit 13 estimates a position at which the dissimilarity has a maximum peak value as the position of the pole based on the dissimilarity at all the DAS coordinate points obtained by the dissimilarity calculation unit 12, and outputs an output signal indicating a DAS coordinate value corresponding to the estimated position.

Hereinafter, the position evaluation apparatus 10 according to the first example embodiment will be described in more detail.

First, the input signal will be described.

The DAS inputs pulsed light to the optical fiber and receives backscattered light (Rayleigh scattered light) for the input pulsed light from the optical fiber. In addition, the DAS can detect a phase difference of the backscattered light occurring between two points on the optical fiber to obtain a phase difference signal

$$Δ φ ( d , t )$$

indicating the detected phase difference. The phase difference signal is proportional to dynamic distortion of the optical fiber in a phase difference evaluation section (gauge length section) which is a section between the two points. The vibration characteristic extraction unit 11 inputs the phase difference signal as the input signal.

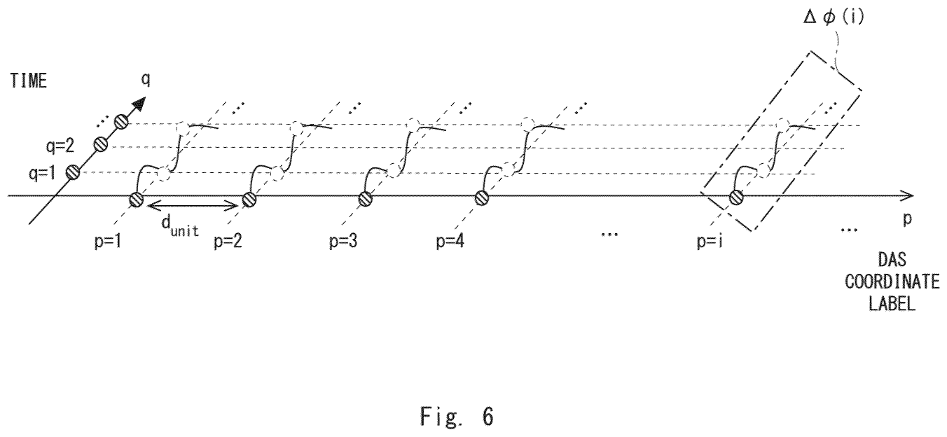

The phase difference signal will be described with reference to FIG. 6.

d in the phase difference signal represents a distance of the optical fiber in a longitudinal direction from the DAS to a measurement point, and is expressed as follows.

$$d = p \times c / ( 2 * {f}_{ADC} ) = p \times {d}_{unit}$$

Here, p represents a DAS coordinate label (integer). f_{ADC} represents a frequency of an analog-to-digital converter (ADC) provided in the DAS. c represents a speed of light in the optical fiber and is expressed as c=c₀/n. c₀ represents a speed of light in vacuum, and n represents a refractive index (about 1.46 in the case of a core made of quartz glass) of an optical fiber core. dᵤₙᵢₜ represents an interval between discrete points in a spatial direction. For example, in a case where f_{ADC} is 125 MHz, dᵤₙᵢₜ is about 0.82 m.

In addition, t in the phase difference signal represents a measurement time and is expressed as follows.

$$t = q \times \frac{1}{{f}_{Pulse}} .$$

Here, q represents a time interval label (integer). f_{Pulse} represents a frequency at which the DAS emits the pulsed light to the optical fiber.

A gauge length is given as follows according to a setting of the DAS.

$$G = {gd}_{unit}$$

Here, g is an integer value.

The smaller the gauge length, the higher the spatial resolution that can be achieved in measurement. Therefore, a smaller gauge length is more preferable.

From the above, the phase difference signal is expressed as follows.

$$Δφ ( d , t ) = Δφ ( p , q ) = [ φ ( p , q ) - φ ( p - g , q ) ] - {φ}_{0} = Δφ ( p ) .$$

$$Here ,$$

$$Δφ ( p )$$

represents a vector representing time-series data at a certain DAS coordinate.

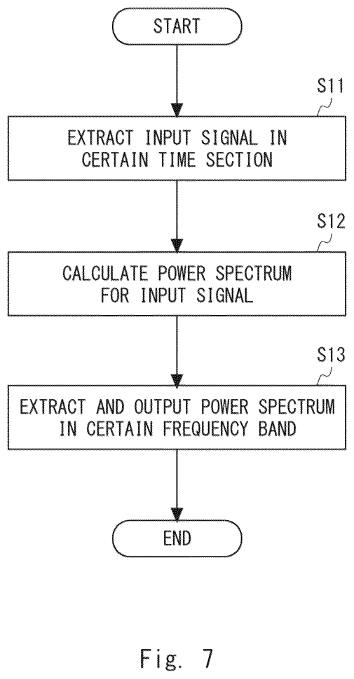

Next, an example of an operation flow of the vibration characteristic extraction unit 11 will be described with reference to FIG. 7.

As illustrated in FIG. 7, first, the vibration characteristic extraction unit 11 extracts an input signal in a certain time section (step S11). The input signal in the certain time section refers to data obtained by cutting a desired time section from the above-described phase difference signal

$$Δφ ( d , t )$$

obtained from the DAS. In a case where the cut data has N components in a time direction, the phase difference signal can be expressed as an N-dimensional vector as follows.

$$Δϕ ( p ) .$$

Next, the vibration characteristic extraction unit 11 calculates a power spectrum for the input signal extracted in step S11 (step S12). Specifically, the vibration characteristic extraction unit 11 performs Fourier transform on

$$Δφ ( p ) . ,$$

and calculates an absolute value (power spectrum)

$$\text{?} ( p ) .$$

of the obtained Fourier component.

Thereafter, the vibration characteristic extraction unit 11 extracts a power spectrum in a certain frequency band from the power spectrum calculated in step S12, and outputs the extracted power spectrum to the dissimilarity calculation unit 12 (step S13). The certain frequency band is a frequency band including the basic vibration mode in the suspension section of the optical fiber. For example, in a case where the maximum peak value of the power spectrum is observed in the vicinity of 40 Hz, the vibration characteristic extraction unit 11 extracts a power spectrum in a frequency band of 30 to 50 Hz.

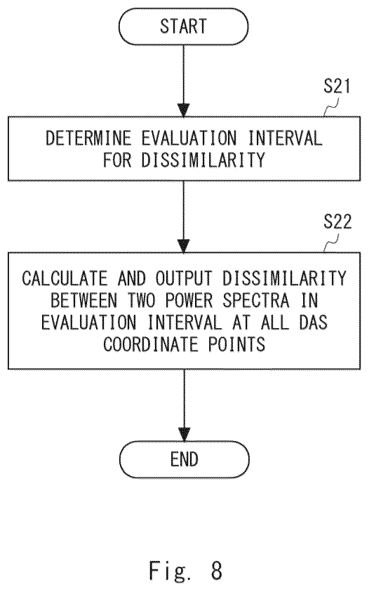

Next, an example of an operation flow of the dissimilarity calculation unit 12 will be described with reference to FIG. 8.

As illustrated in FIG. 8, first, the dissimilarity calculation unit 12 determines an evaluation interval for evaluating dissimilarity (step S21). The evaluation interval for evaluating the dissimilarity is an interval for evaluating dissimilarity in power spectrum between two pieces of data.

Thereafter, the dissimilarity calculation unit 12 calculates the dissimilarity between the two power spectra in the evaluation interval determined in step S21 at all the DAS coordinate points based on the power spectra obtained by the vibration characteristic extraction unit 11, and outputs the calculated dissimilarity to the pole position calculation unit 13 (step S22).

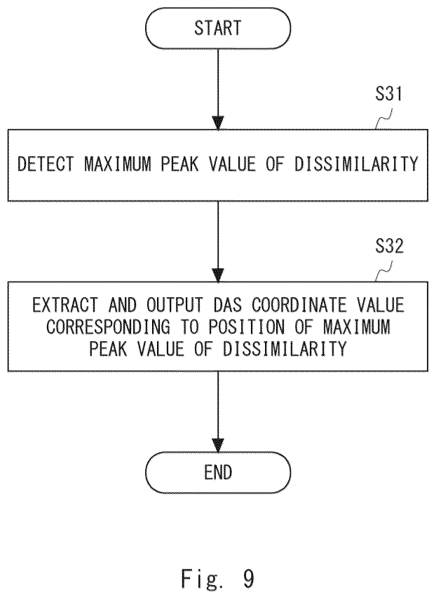

Next, an example of an operation flow of the pole position calculation unit 13 will be described with reference to FIG. 9.

As illustrated in FIG. 9, first, the pole position calculation unit 13 detects the maximum peak value of the dissimilarity based on the dissimilarity at all the DAS coordinate points obtained by the dissimilarity calculation unit 12 (step S31). A method of detecting the maximum peak value may be any method. In addition, it is sufficient if the number of maximum peak values to be detected is determined by, for example, the number of poles whose positions are to be estimated.

Thereafter, the pole position calculation unit 13 estimates a position of the maximum peak value detected in step S31 as the position of the pole, extracts the DAS coordinate value corresponding to the estimated position, and outputs an output signal indicating the extracted DAS coordinate value (step S32).

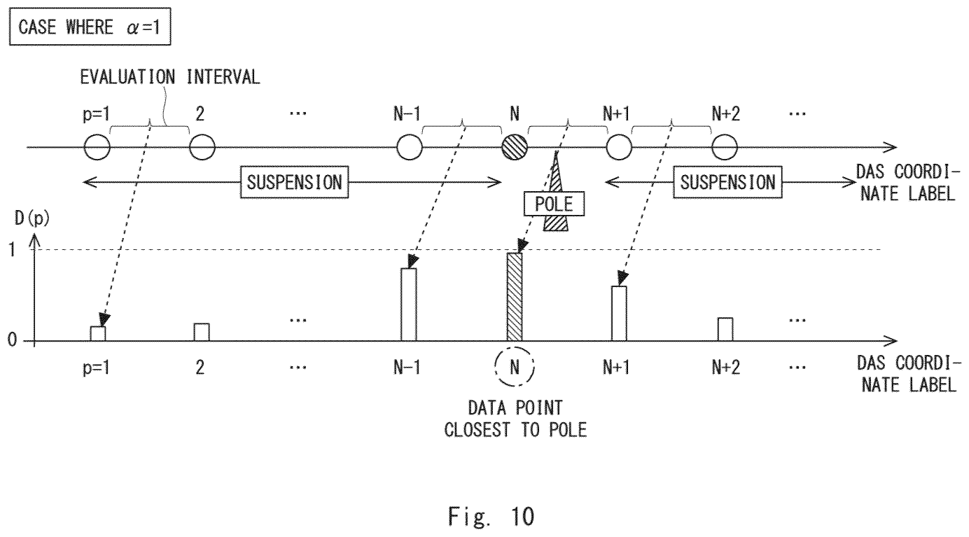

Next, an example of a method of analyzing the dissimilarity by the pole position calculation unit 13 will be described with reference to FIG. 10. Here, the dissimilarity calculation unit 12 calculates dissimilarity D(p) between a power spectrum

$$\text{?} ( p ) .$$

and a power spectrum

$$\text{?} ( p + a ) .$$

as follows.

$$d ( p ) = ( 1 - \frac{\text{?} ( p ) \cdot \text{?} ( p + a )}{[ \vert \text{?} ( p ) \vert \vert ( \text{?} ( p + a ) \vert ]} ) / 2$$

Here, a represents the evaluation interval for the dissimilarity.

For example, in a case where both of

$$\text{?} ( p ) .$$

$$and$$

$$\text{?} ( p + a ) .$$

are the power spectra of the suspension portion and do not straddle the pole, D(p) has a value close to 0 because the power spectra are similar to each other.

On the other hand, in a case where

$$\text{?} ( p ) .$$

$$and$$

$$\text{?} ( p * a ) .$$

straddle the suspension portion and the pole, the similarity between the power spectra becomes low, and thus, D(p) has a value close to 1.

Therefore, the pole position calculation unit 13 analyzes the dissimilarity from the above viewpoint.

FIG. 10 illustrates an example in a case where the evaluation interval a is 1.

In the example of FIG. 10, the pole position calculation unit 13 estimates, as the position of the pole, a position of p=N where D(p) is closest to 1, that is, a position of p=N where the dissimilarity has the maximum peak value, and outputs the DAS coordinate value corresponding to the estimated position.

Next, a specific example of an operation of the position evaluation apparatus 10 according to the first example embodiment will be described.

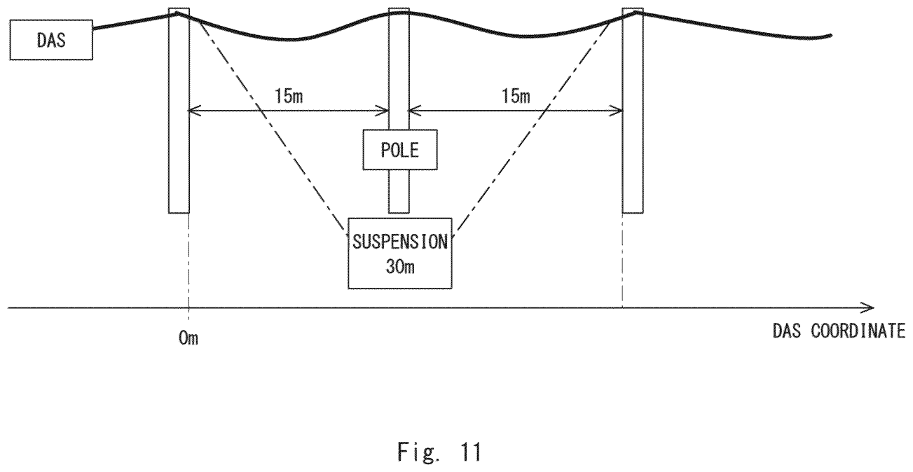

In the specific example, as illustrated in FIG. 11, a sensing system in which the optical fiber of about 30 m is suspended on the pole, and the DAS is connected to a left end of the optical fiber is assumed.

Under this assumption, in the specific example, a left portion of the suspension section of the optical cable is set to 0 m as the DAS coordinate value (the length of the optical fiber), and the DAS coordinate value of the position of the pole is estimated.

First, the vibration characteristic extraction unit 11 extracts a power spectrum in a frequency band of 0 to 50 Hz for an input signal for 10 seconds. Here, dᵤₙᵢₜ=0.82 m and g=2.

Next, the dissimilarity calculation unit 12 calculates the dissimilarity by using these power spectra. Here, a=1.

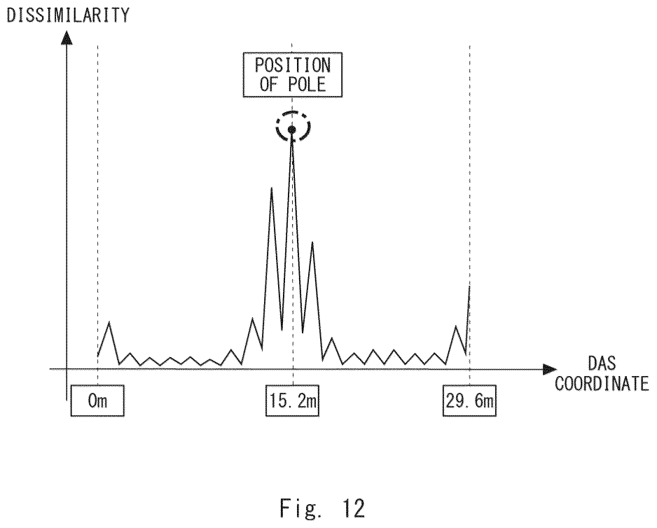

As a result, it is assumed that the dissimilarity as illustrated in FIG. 12 is obtained.

In this case, the pole position calculation unit 13 estimates the position where the dissimilarity has the maximum peak as the position of the pole, and outputs the DAS coordinate value of 15.2 m corresponding to the estimated position.

As described above, according to the first example embodiment, the vibration characteristic extraction unit 11 inputs the phase difference signal of the backscattered light as the input signal, extracts the input signal in a certain time section, calculates the power spectrum for the extracted input signal, and extracts the power spectrum in a certain frequency band from the calculated power spectrum. The dissimilarity calculation unit 12 calculates the dissimilarity between the two power spectra at all the DAS coordinate points in the evaluation interval. The pole position calculation unit 13 estimates the position at which the dissimilarity has the maximum peak value as the position of the pole, and extracts and outputs the DAS coordinate value corresponding to the estimated position.

Therefore, even a point where vibration of the maximum intensity does not occur can be estimated as the position of the pole as long as the dissimilarity between the power spectra in the evaluation interval is maximized. As a result, it is possible to improve accuracy in estimating the position of the pole which is an environment change position of the optical fiber.

### Second Example Embodiment

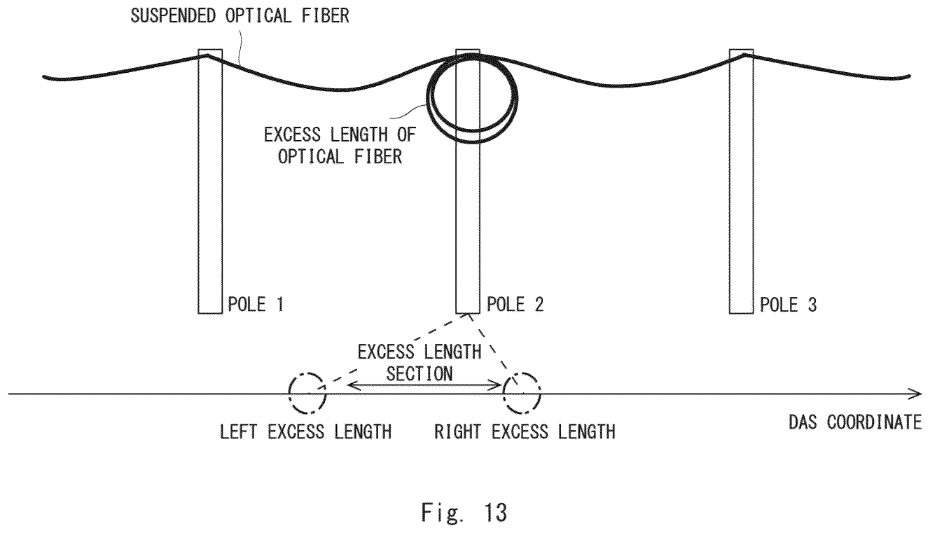

In a second example embodiment, as illustrated in FIG. 13, a position of the excess length section of the optical fiber is estimated and output as a DAS coordinate value. Specifically, a left end and a right end of the excess length of the optical fiber are expressed as a left excess length and a right excess length, respectively, and DAS coordinate values at positions of the left excess length and the right excess length are estimated and output.

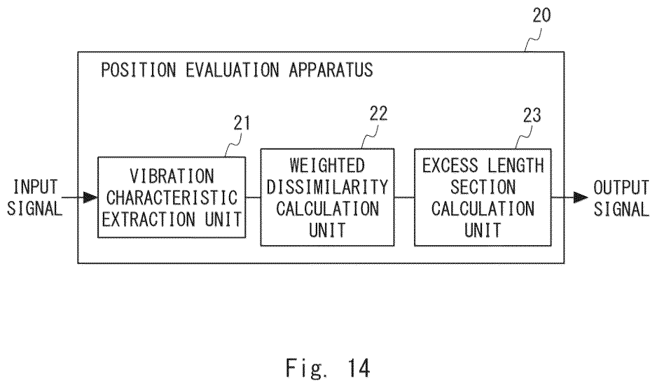

A configuration example of a position evaluation apparatus 20 according to the second example embodiment will be described with reference to FIG. 14.

As illustrated in FIG. 14, the position evaluation apparatus 20 according to the second example embodiment includes a vibration characteristic extraction unit 21, a weighted dissimilarity calculation unit 22, and an excess length section calculation unit 23.

An input signal input to the vibration characteristic extraction unit 21 is similar to the input signal according to the first example embodiment described above.

The vibration characteristic extraction unit 21 is similar to the vibration characteristic extraction unit 11 according to the first example embodiment described above.

The weighted dissimilarity calculation unit 22 calculates a frequency average value of power spectra at all DAS coordinate points based on the power spectra obtained by the vibration characteristic extraction unit 21. In addition, the weighted dissimilarity calculation unit 22 determines an evaluation interval for evaluating dissimilarity. In addition, the weighted dissimilarity calculation unit 22 calculates dissimilarity between the two power spectra at all DAS coordinate points in the evaluation interval based on the power spectra obtained by the vibration characteristic extraction unit 21. In addition, the weighted dissimilarity calculation unit 22 calculates weighted dissimilarity obtained by weighting the dissimilarity with the frequency average value of the power spectra at all the DAS coordinate points based on the obtained dissimilarity at all the DAS coordinate points and the obtained frequency average value of the power spectra, and outputs the calculated weighted dissimilarity. In addition, the weighted dissimilarity calculation unit 22 outputs the frequency average value of the power spectra at all the DAS coordinate points.

The excess length section calculation unit 23 sets an excess length section range on the DAS coordinate based on the frequency average value of the power spectra at all the DAS coordinate points obtained by the weighted dissimilarity calculation unit 22. In addition, based on the weighted dissimilarity at all the DAS coordinate points obtained by the weighted dissimilarity calculation unit 22, the excess length section calculation unit 23 estimates positions where the weighted dissimilarity has the maximum peak value in the set excess length section range as the positions of the left excess length and the right excess length, extracts a DAS coordinate value corresponding to the estimated position, and outputs an output signal indicating the extracted DAS coordinate value.

Hereinafter, the position evaluation apparatus 20 according to the second example embodiment will be described in more detail.

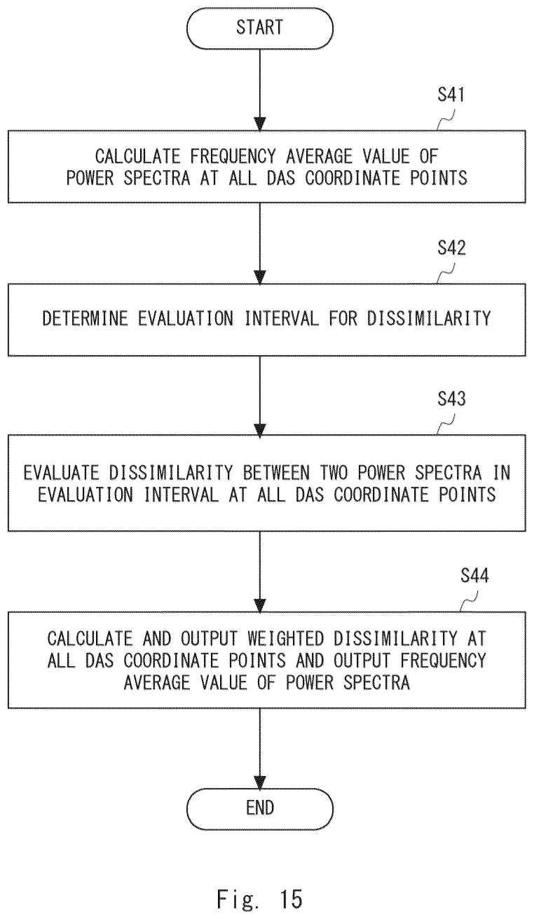

First, an example of an operation flow of the weighted dissimilarity calculation unit 22 will be described with reference to FIG. 15.

As illustrated in FIG. 15, first, the weighted dissimilarity calculation unit 22 calculates a frequency average value of power spectra at all the DAS coordinate points based on the power spectra obtained by the vibration characteristic extraction unit 21 (step S41).

Next, the weighted dissimilarity calculation unit 22 determines an evaluation interval for evaluating dissimilarity (step S42).

Next, the weighted dissimilarity calculation unit 22 calculates dissimilarity between the two power spectra at all the DAS coordinate points in the evaluation interval determined in step S42 based on the power spectrum obtained by the vibration characteristic extraction unit 21 (step S43).

Thereafter, the weighted dissimilarity calculation unit 22 calculates weighted dissimilarity at all the DAS coordinate points based on the frequency average value of the power spectra and the dissimilarity at all the DAS coordinate points obtained in steps S41 and S43, and outputs the calculated weighted dissimilarity to the excess length section calculation unit 23. The weighted dissimilarity is obtained by weighting the dissimilarity with the frequency average value of the power spectra, and is obtained by multiplying the frequency average value of the power spectra and the dissimilarity. The weighted dissimilarity can characterize a state in which the dissimilarity is high and an intensity of the vibration is low. Further, the weighted dissimilarity calculation unit 22 outputs the frequency average value of the power spectra at all the DAS coordinate points obtained in step S41 to the excess length section calculation unit 23 (step S44).

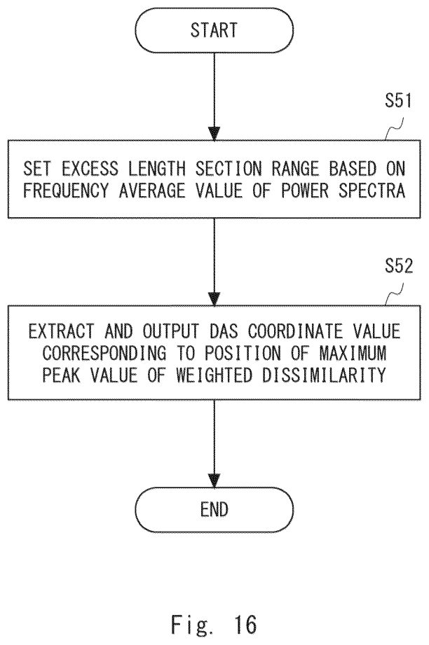

Next, an example of an operation flow of the excess length section calculation unit 23 will be described with reference to FIG. 16.

As illustrated in FIG. 16, first, the excess length section calculation unit 23 sets an excess length section range on the DAS coordinate based on the frequency average value of the power spectra at all the DAS coordinate points obtained by the weighted dissimilarity calculation unit 22 (step S51). Specifically, the excess length section calculation unit 23 sets, as the excess length section range, a range on the DAS coordinate in which the frequency average value of the power spectra falls below a threshold. As a result, a rough range considered as the excess length section of the optical fiber is set. The threshold is a percentile value with respect to the frequency average value of the power spectra.

Thereafter, based on the weighted dissimilarity at all the DAS coordinate points obtained by the weighted dissimilarity calculation unit 22, the excess length section calculation unit 23 estimates the positions where the weighted dissimilarity has the maximum peak value in the excess length section range set in step S51 as the positions of the left excess length and the right excess length of the optical fiber. Then, the excess length section calculation unit 23 extracts DAS coordinate values corresponding to the estimated positions of the left excess length and the right excess length, and outputs an output signal indicating the extracted DAS coordinate values (step S52).

Next, a specific example of an operation of the position evaluation apparatus 20 according to the second example embodiment will be described.

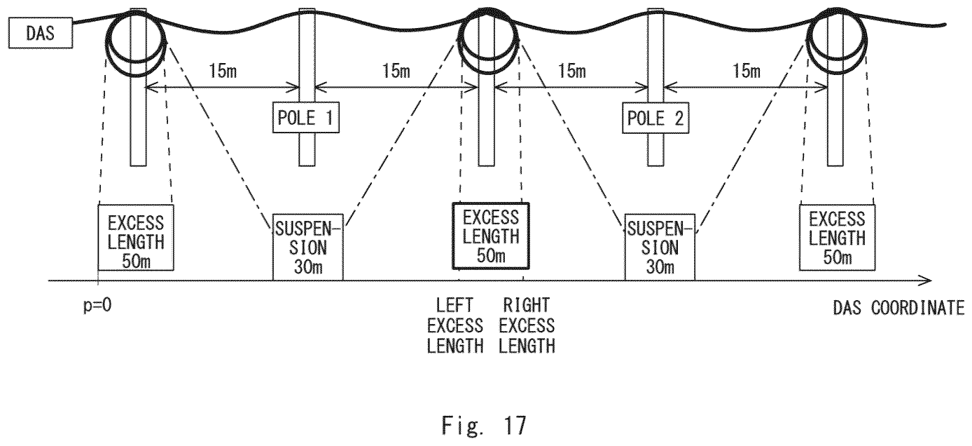

In the specific example, as illustrated in FIG. 17, a sensing system in which three poles include the excess length section of the optical fiber of about 50 m, the optical fiber of about 30 m is suspended between the three poles, and the DAS is connected to the left end of the optical fiber is assumed. Therefore, the total length of the optical fiber is about 210 m.

Under this assumption, in the specific example, a left excess length portion of the optical fiber included in the left pole among the three poles described above is set to 0 m as the DAS coordinate value (the length of the optical fiber), and the DAS coordinate values of the positions of the left excess length and the right excess length of the optical fiber included in the center pole (around 80 m to 130 m as the DAS coordinate value) are estimated.

First, the vibration characteristic extraction unit 21 extracts a power spectrum in a frequency band of 0 to 50 Hz for an input signal for 10 seconds. Here, dᵤₙᵢₜ=0.82 m and g=2.

Next, the weighted dissimilarity calculation unit 22 calculates the frequency average value, the dissimilarity, and the weighted dissimilarity of the power spectra at all the DAS coordinate points by using the power spectra. Here, a=2.

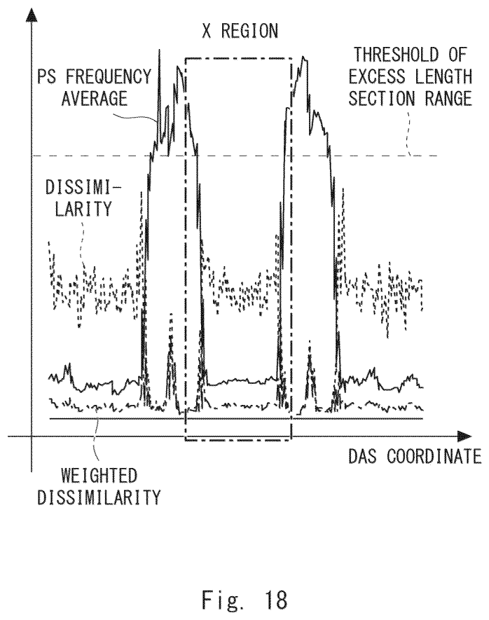

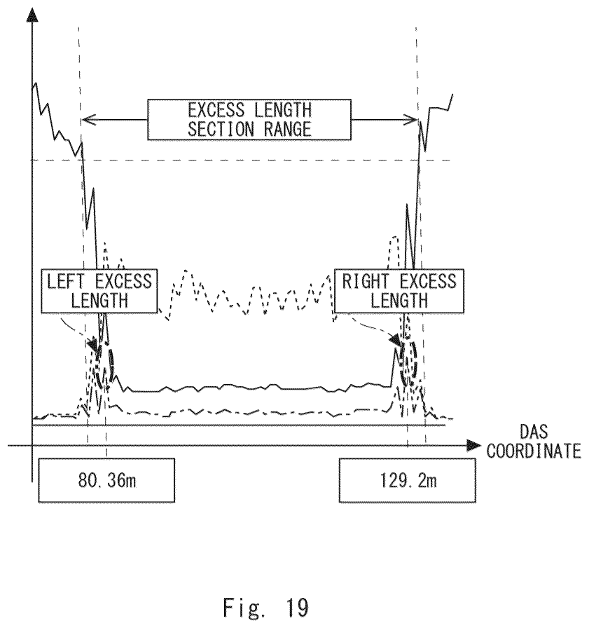

As a result, it is assumed that the frequency average value, the dissimilarity, and the weighted dissimilarity of the power spectra as illustrated in FIGS. 18 and 19 are obtained. FIG. 19 is an enlarged view of an X region illustrated in FIG. 18.

Here, since the excess length section of the optical fiber is hardly affected by wind, the frequency average value of the power spectra in the excess length section becomes small.

Therefore, first, the excess length section calculation unit 23 sets, as the excess length section range that is a rough range considered as the excess length section of the optical fiber, a range on the DAS coordinate in which the frequency average value of the power spectra falls below the threshold. Here, the threshold is set to 70 percentile.

On the other hand, at a position where the optical fiber changes from the excess length section to the suspension section, vibration applied to the optical fiber changes, and a characteristic of backscattered light changes, and thus, the dissimilarity increases. At this time, the weighted dissimilarity obtained by weighting the dissimilarity with the frequency average value of the power spectra takes the maximum peak value at the left and right excess length portions of the optical fiber.

Therefore, next, the excess length section calculation unit 23 estimates the positions where the weighted dissimilarity has the maximum peak value in the excess length section range as the positions of the left excess length and the right excess length of the optical fiber, and outputs DAS coordinate values of 80.36 m and 129.2 m corresponding to the estimated positions.

As described above, according to the second example embodiment, the vibration characteristic extraction unit 21 inputs the phase difference signal of the backscattered light as the input signal, extracts the input signal in a certain time section, calculates the power spectrum for the extracted input signal, and extracts the power spectrum in a certain frequency band from the calculated power spectrum. The weighted dissimilarity calculation unit 22 calculates the frequency average value of the power spectra at all the DAS coordinate points, calculates the dissimilarity between the two power spectra in the evaluation interval, and calculates the weighted dissimilarity obtained by weighting the dissimilarity with the frequency average value of the power spectra. The excess length section calculation unit 23 sets the excess length section range on the DAS coordinate, estimates the positions where the weighted dissimilarity has the maximum peak value in the set excess length section range as the positions of the left excess length and the right excess length of the optical fiber, and extracts and outputs the DAS coordinate values corresponding to the estimated positions.

Therefore, even points where vibration of the maximum intensity does not occur can be estimated as the positions of the left excess length and the right excess length of the optical fiber as long as the weighted dissimilarity between the power spectra in the evaluation interval is maximized. As a result, it is possible to improve accuracy in estimating the position of the excess length section which is an environment change position of the optical fiber.

### Third Example Embodiment

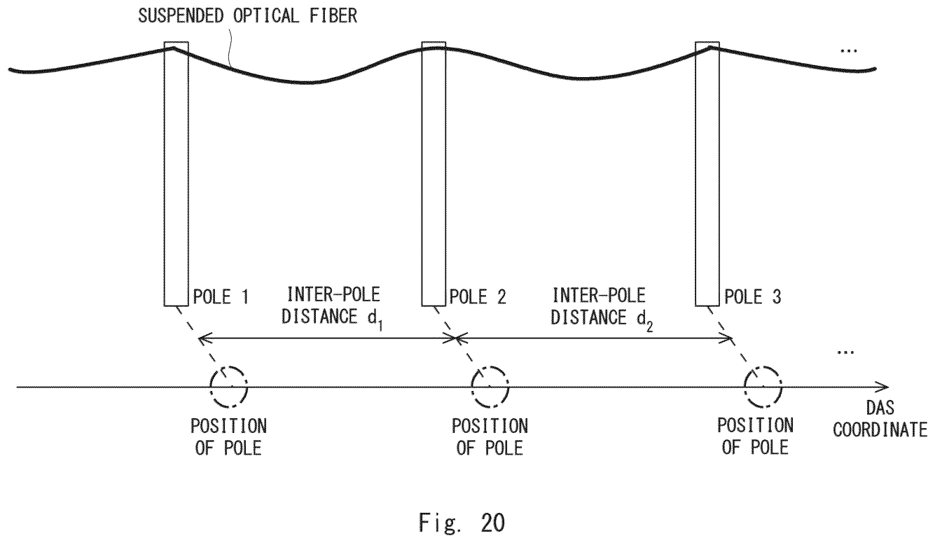

In a third example embodiment, as illustrated in FIG. 20, a position of a pole is estimated and output as a DAS coordinate value with reference to an inter-pole distance between poles given in advance.

The inter-pole distance indicates a distance between adjacent poles, and is given in advance from the following information, for example.
Measurement of the inter-pole distance with reference to global positioning system (GPS) information or map information
An optical fiber length recorded in a case where an optical fiber is suspended between two poles

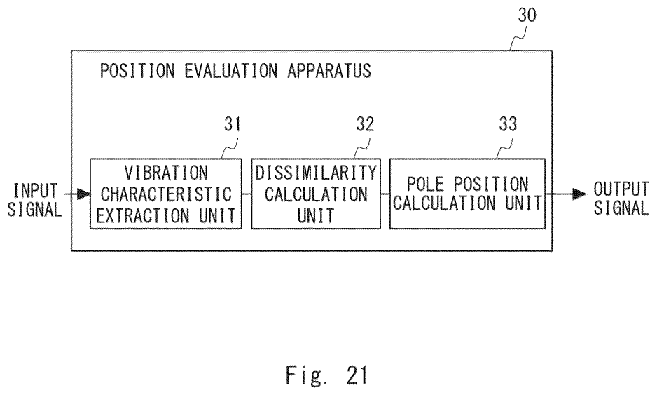

A configuration example of a position evaluation apparatus 30 according to the third example embodiment will be described with reference to FIG. 21.

As illustrated in FIG. 21, the position evaluation apparatus 30 according to the third example embodiment includes a vibration characteristic extraction unit 31, a dissimilarity calculation unit 32, and a pole position calculation unit 33.

An input signal input to the vibration characteristic extraction unit 31 is similar to the input signal according to the first and second example embodiments described above.

The vibration characteristic extraction unit 31 is similar to the vibration characteristic extraction units 11 and 21 according to the first and second example embodiments described above.

The dissimilarity calculation unit 32 is similar to the dissimilarity calculation unit 12 according to the first example embodiment described above.

The pole position calculation unit 33 determines a section including all the poles whose positions are to be estimated as an analysis target section. The pole position calculation unit 33 configures a window function in the analysis target section based on the inter-pole distance given in advance. Further, the pole position calculation unit 33 searches for a DAS coordinate value (offset point) at which a value of a cross-correlation function between the window function and dissimilarity has a maximum value based on dissimilarity at all the DAS coordinate points obtained by the dissimilarity calculation unit 32 and the window function configured as described above. The pole position calculation unit 33 also outputs the position of each pole as the DAS coordinate value based on the inter-pole distance given in advance and the offset point searched above. Specifically, the pole position calculation unit 33 estimates a position of the offset point and a position obtained by adding the inter-pole distance to the offset point as the positions of the poles, and outputs the DAS coordinate values corresponding to the estimated positions.

Hereinafter, the position evaluation apparatus 30 according to the third example embodiment will be described in more detail.

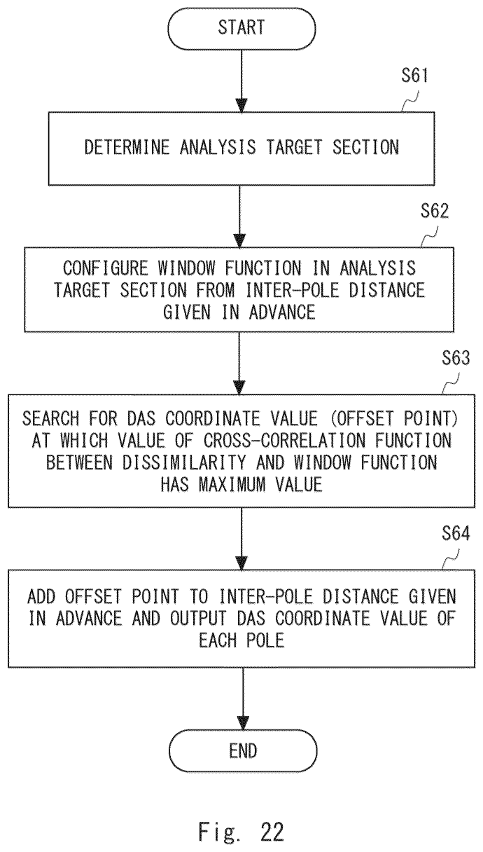

First, an example of an operation flow of the pole position calculation unit 33 will be described with reference to FIG. 22.

As illustrated in FIG. 22, the pole position calculation unit 33 first determines an analysis target section (step S61). The analysis target section is a DAS coordinate section including all the poles whose positions are to be estimated.

Next, the pole position calculation unit 33 configures a window function in the analysis target section based on an inter-pole distance given in advance (step S62). Details of the window function are described below.

Next, the pole position calculation unit 33 searches for a DAS coordinate value (offset point) at which a value of a cross-correlation function between the window function and dissimilarity has a maximum value in the analysis target section based on dissimilarity at all the DAS coordinate points obtained by the dissimilarity calculation unit 32 and the window function configured in step S62 (step S63).

Thereafter, the pole position calculation unit 33 adds the inter-pole distance to the offset point based on the inter-pole distance given in advance and the offset point searched in step S63, thereby outputting the position of each pole as the DAS coordinate value (step S64). Specifically, the pole position calculation unit 33 estimates a position of the offset point and a position obtained by adding the inter-pole distance to the offset point as the positions of the poles, and outputs the DAS coordinate values corresponding to the estimated positions.

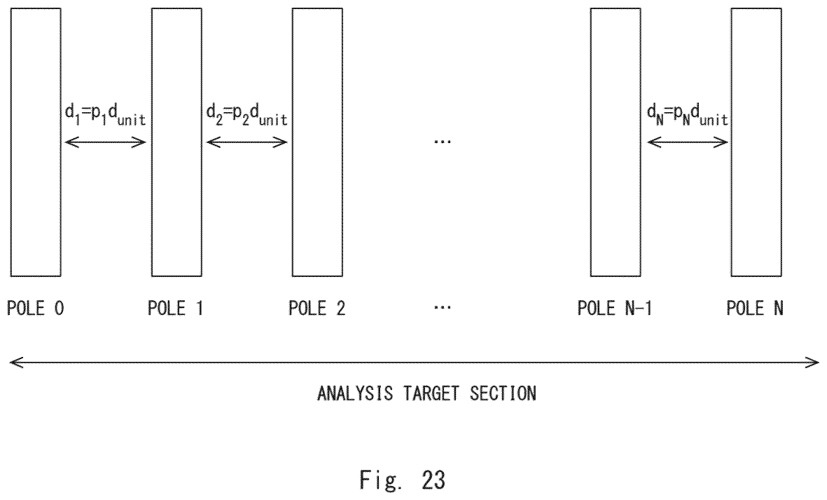

Next, an example of the analysis target section determined by the pole position calculation unit 33 will be described with reference to FIG. 23. As illustrated in FIG. 23, the pole position calculation unit 33 sets a label of each pole and determines the analysis target section. As described above, the analysis target section is a DAS coordinate section including all the poles (here, poles 0 to N) whose positions are to be estimated.

Here, inter-pole distances according to the label of each pole are defined as d₁, d₂, and the like.

A DAS coordinate value from the DAS to a left end (a point of p=0) of the analysis target section is set to d₀. The DAS coordinate value is set to an arbitrary value so as to include the pole 0.

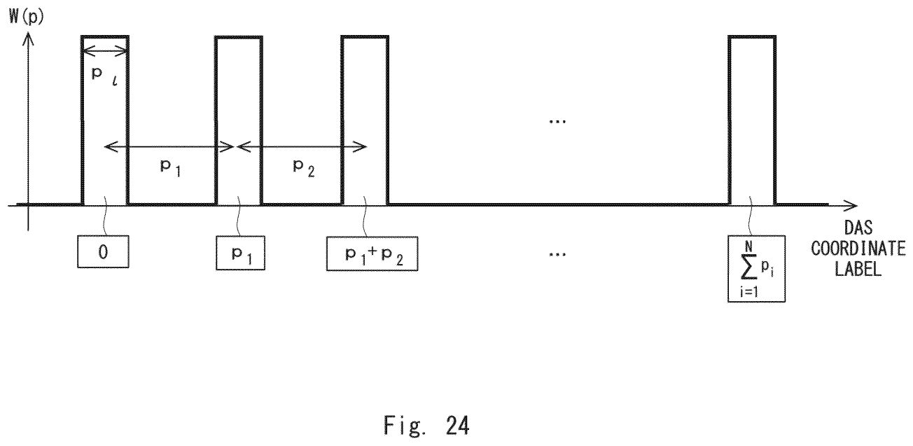

Next, an example of the window function configured by the pole position calculation unit 33 will be described with reference to FIG. 24.

As illustrated in FIG. 24, the window function is configured as follows from inter-pole distances p₁, p₂, and the like

$$W ( p ) = θ ( p - {\sum }_{i = 1}^{N} {p}_{i} + \frac{{p}_{l}}{2} ) θ ( {\sum }_{i = 1}^{N} {p}_{i} + \frac{{p}_{l}}{2} - p ) , θ ( x ) = \{ \begin{matrix}0 , & x < 0 \\ 1 , & x \geq 0\end{matrix}$$

Further, it is sufficient if a window width p₁ of the window function is appropriately set as a value of about a. In order to improve accuracy of an analysis result, the analysis may be performed while changing a value of the window width p₁.

Next, an example of the cross-correlation function calculated by the pole position calculation unit 33 will be described.

In the analysis target section, a cross-correlation function between a window function W(p) and dissimilarity D(p) is given as follows.

$$C ( {p}_{offset} ) = \frac{1}{N} {\sum }_{p = 0}^{N} D ( p ) W ( p - {p}_{offset} )$$

Here, a numerical value of the dissimilarity D(p) increases in the vicinity of the position of the pole.

Therefore, the pole position calculation unit 33 searches for a DAS coordinate value (offset point) p_{offset} at which the value of the cross-correlation function has the maximum value in the analysis target section.

After determining the offset point p_{offset}, the pole position calculation unit 33 outputs the following DAS coordinate value indicating the position of each pole N′.

$${d}_{0} + {d}_{unit} ( {p}_{offset} + {\sum }_{i = 1}^{{N}^{′}} {p}_{i} )$$

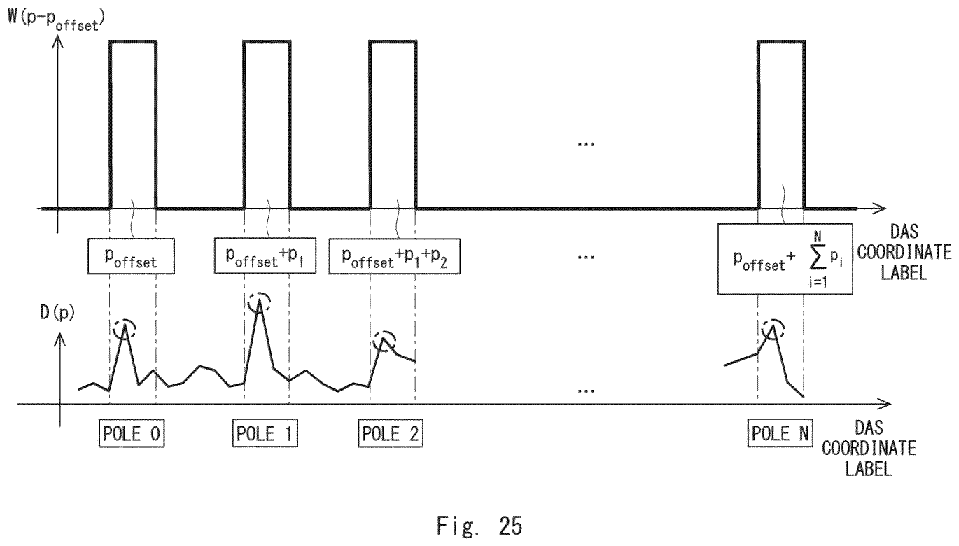

FIG. 25 illustrates an example of a relationship between the window function and the dissimilarity in a case where the appropriate offset point p_{offset} is obtained by the pole position calculation unit 33. In the example of FIG. 25, the offset point p_{offset} is the DAS coordinate value of the pole 0, and a value obtained by adding the inter-pole distance given in advance to the offset point p_{offset} is the DAS coordinate value of each of the poles 1 to N.

As described above, according to the third example embodiment, the vibration characteristic extraction unit 31 inputs the phase difference signal of the backscattered light as the input signal, extracts the input signal in a certain time section, calculates the power spectrum for the extracted input signal, and extracts the power spectrum in a certain frequency band from the calculated power spectrum. The dissimilarity calculation unit 32 calculates the dissimilarity between the two power spectra at all the DAS coordinate points in the evaluation interval. The pole position calculation unit 33 determines the analysis target section, and configures the window function in the analysis target section based on the inter-pole distance given in advance. The pole position calculation unit 33 also searches for the DAS coordinate value (offset point) at which the value of the cross-correlation function between the window function and the dissimilarity has the maximum value, adds the inter-pole distance given in advance to the offset point to output the DAS coordinate value corresponding to the position of each pole. That is, the pole position calculation unit 33 estimates the position of the offset point and the position obtained by adding the inter-pole distance to the offset point as the positions of the poles, and outputs the DAS coordinate values corresponding to the estimated positions.

Therefore, a point at which vibration of the maximum intensity does not occur can also be estimated as the position of each pole. As a result, it is possible to improve accuracy in estimating the position of each pole which is an environment change position of the optical fiber. In addition, it is possible to simultaneously estimate the positions of the respective poles.

### Fourth Example Embodiment

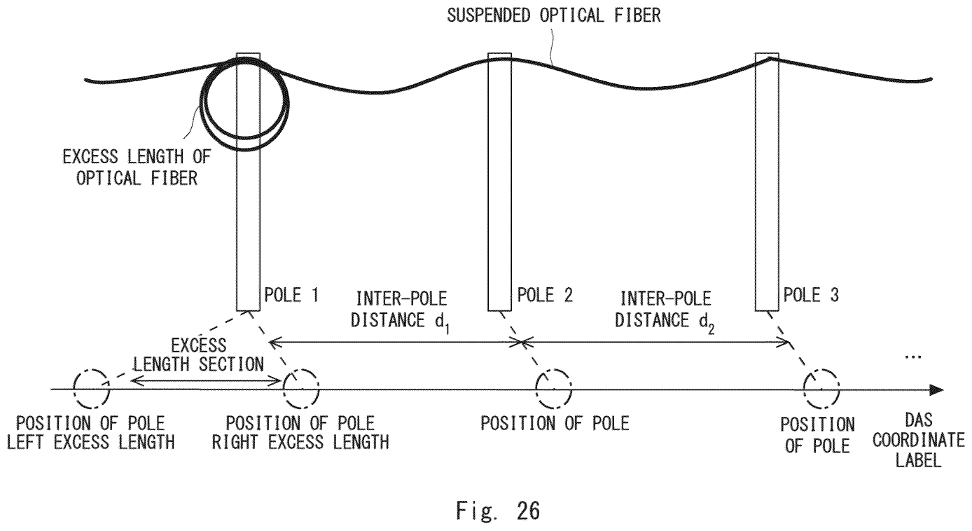

In a fourth example embodiment, as illustrated in FIG. 26, in a case where a pole including an excess length section of an optical fiber is known, a position of each pole and a position of the excess length section are estimated and output as DAS coordinate values with reference to an inter-pole distance given in advance.

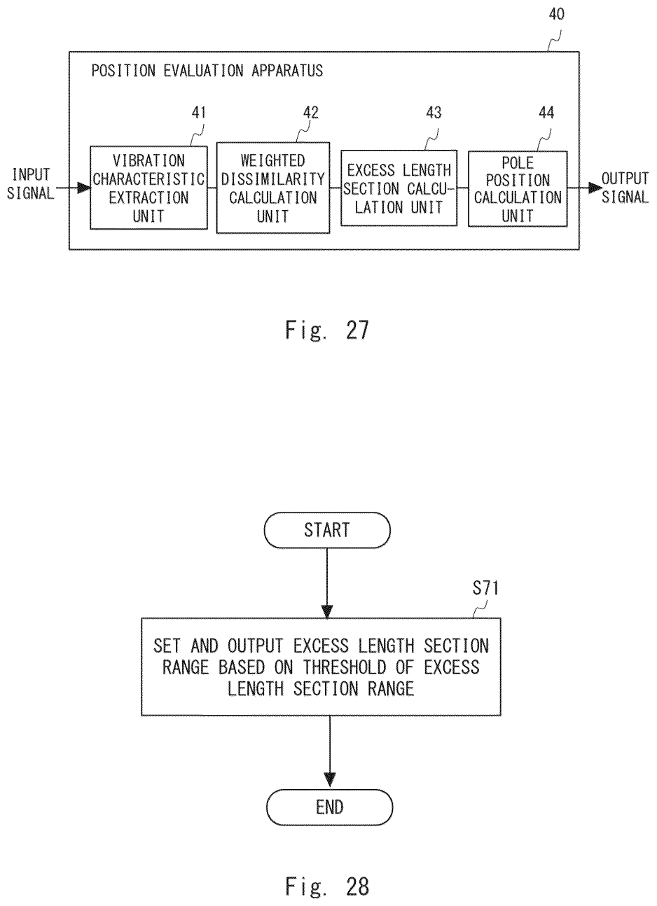

A configuration example of a position evaluation apparatus 40 according to the fourth example embodiment will be described with reference to FIG. 27.

As illustrated in FIG. 27, the position evaluation apparatus 40 according to the fourth example embodiment includes a vibration characteristic extraction unit 41, a weighted dissimilarity calculation unit 42, an excess length section calculation unit 43, and a pole position calculation unit 44.

An input signal input to the vibration characteristic extraction unit 41 is similar to the input signal according to the first to third example embodiments described above.

The vibration characteristic extraction unit 41 is similar to the vibration characteristic extraction units 11, 21, and 31 according to the first to third example embodiments described above.

The weighted dissimilarity calculation unit 42 is similar to the weighted dissimilarity calculation unit 22 according to the second example embodiment described above.

The excess length section calculation unit 43 sets an excess length section range on a DAS coordinate based on a frequency average value of power spectra at all DAS coordinate points obtained by the weighted dissimilarity calculation unit 42.

The pole position calculation unit 44 determines a section from the pole including the excess length section to the next pole including the excess length section as an analysis target section. The pole position calculation unit 44 configures a window function in the analysis target section based on the inter-pole distance given in advance. In addition, the pole position calculation unit 44 searches for a DAS coordinate value (offset point) at which a value of a cross-correlation function between the window function and weighted dissimilarity has a maximum value based on the weighted dissimilarity at all DAS coordinate points obtained by the weighted dissimilarity calculation unit 42 and the window function configured as described above. In addition, the pole position calculation unit 44 outputs the DAS coordinate value corresponding to the position of each pole based on the inter-pole distance given in advance and the offset point searched above. That is, the pole position calculation unit 44 estimates a position of the offset point and a position obtained by adding the inter-pole distance to the offset point as the positions of the poles, and outputs the DAS coordinate values corresponding to the estimated positions.

In addition, the pole position calculation unit 44 outputs a DAS coordinate value corresponding to a position of a right excess length of the optical fiber based on the offset point searched above. That is, the pole position calculation unit 44 estimates the position of the offset point as the position of the right excess length, and outputs the DAS coordinate value corresponding to the estimated position. The pole position calculation unit 44 outputs a DAS coordinate value corresponding to a position of a left excess length of the optical fiber based on the weighted dissimilarity of each position on a side closer to the DAS than the position of the pole including the excess length section. That is, the pole position calculation unit 44 estimates, as the position of the left excess length, a position where the weighted dissimilarity has the maximum peak value on a side closer to the DAS than the position of the pole including the excess length section, and outputs the DAS coordinate value corresponding to the estimated position.

Hereinafter, the position evaluation apparatus 40 according to the fourth example embodiment will be described in more detail.

First, an example of an operation flow of the excess length section calculation unit 43 will be described with reference to FIG. 28.

As illustrated in FIG. 28, the excess length section calculation unit 43 sets an excess length section range on the DAS coordinate based on the frequency average value of the power spectra at all the DAS coordinate points obtained by the weighted dissimilarity calculation unit 42 (step S71). Specifically, the excess length section calculation unit 43 sets, as the excess length section range, a range on the DAS coordinate in which the frequency average value of the power spectra falls below a threshold. As a result, the excess length section range, which is a rough range considered as the excess length section of the optical fiber, is set. The threshold is a percentile value with respect to the frequency average value of the power spectra. The number of excess length section ranges is equal to the number of poles including the excess length section.

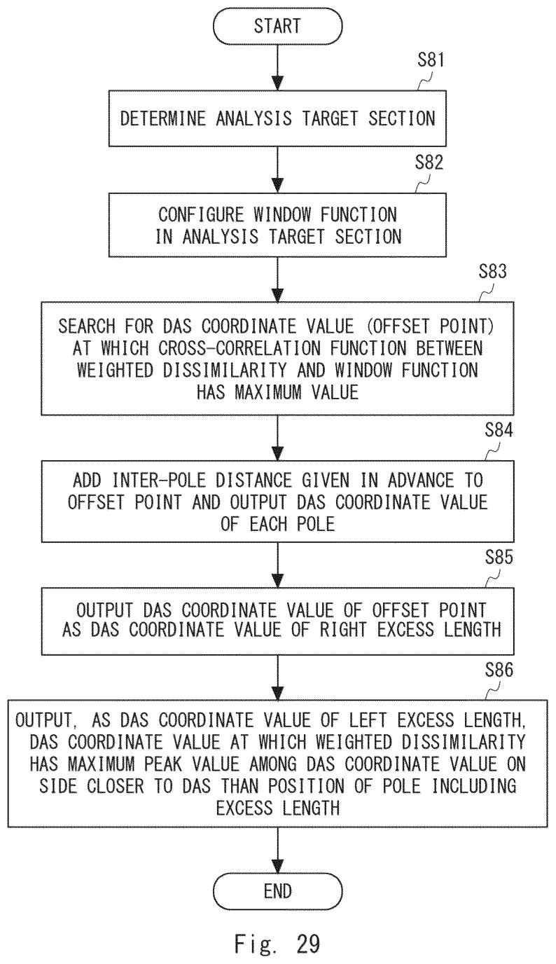

Next, an example of an operation flow of the pole position calculation unit 44 will be described with reference to FIG. 29.

As illustrated in FIG. 29, the pole position calculation unit 44 first determines an analysis target section (step S81). The analysis target section is a DAS coordinate section from the pole including the excess length section to the next pole including the excess length section.

Next, the pole position calculation unit 44 configures a window function in the analysis target section based on an inter-pole distance given in advance (step S82). The window function is similar to the window function according to the third example embodiment described above.

Next, the pole position calculation unit 44 searches for a DAS coordinate value (offset point) at which a value of a cross-correlation function between the window function and weighted dissimilarity has the maximum value in the analysis target section based on the weighted dissimilarity at all the DAS coordinate points obtained by the weighted dissimilarity calculation unit 42 and the window function configured in step S82 (step S83).

Next, the pole position calculation unit 44 adds the offset point to the inter-pole distance based on the inter-pole distance given in advance and the offset point searched in step S83, thereby outputting a DAS coordinate value corresponding to the position of each pole (step S84). That is, the pole position calculation unit 44 estimates a position of the offset point and a position obtained by adding the inter-pole distance to the offset point as the positions of the poles, and outputs the DAS coordinate values corresponding to the estimated positions.

Next, the pole position calculation unit 44 outputs a DAS coordinate value of the offset point searched in step S83 as a DAS coordinate value corresponding to the position of the right excess length of the optical fiber (step S85). That is, the pole position calculation unit 44 estimates the position of the offset point as the position of the right excess length, and outputs the DAS coordinate value corresponding to the estimated position.

Thereafter, the pole position calculation unit 44 outputs, as a DAS coordinate value corresponding to the position of the left excess length of the optical fiber, a DAS coordinate value corresponding to a position where the weighted dissimilarity has the maximum peak value based on the weighted dissimilarity of each position on a side closer to the DAS than the position of the pole including the excess length section (step S86). That is, the pole position calculation unit 44 estimates, as the position of the left excess length, a position where the weighted dissimilarity has the maximum peak value on a side closer to the DAS than the position of the pole including the excess length section, and outputs the DAS coordinate value corresponding to the estimated position.

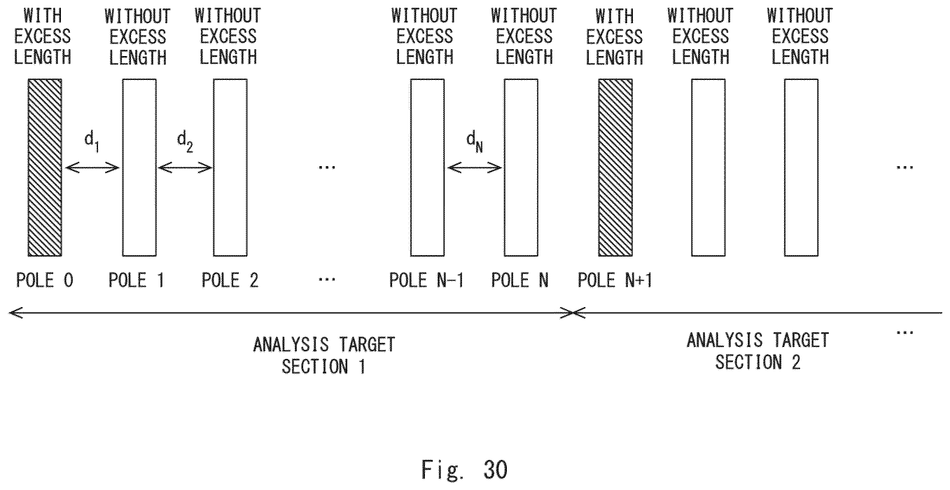

Next, an example of the analysis target section determined by the pole position calculation unit 44 will be described with reference to FIG. 30.

As illustrated in FIG. 30, the pole position calculation unit 44 sets a label of each pole and determines the analysis target section. As described above, the analysis target section is a DAS coordinate section from the pole including the excess length section to the next pole including the excess length section.

In the example of FIG. 30, a pole 0 includes the excess length section, and the next pole including the excess length section is a pole N+1. Therefore, the pole position calculation unit 44 determines a section from the pole 0 to a pole N immediately before the pole N+1 as an analysis target section 1, and determines a section after the pole N+1 as an analysis target section 2.

Here, inter-pole distances according to the label of each pole are defined as d₁, d₂, and the like.

A DAS coordinate value from the DAS to a left end (a point of p=0) of the analysis target section is set to do. The DAS coordinate value is set to an arbitrary value so as to include the pole 0.

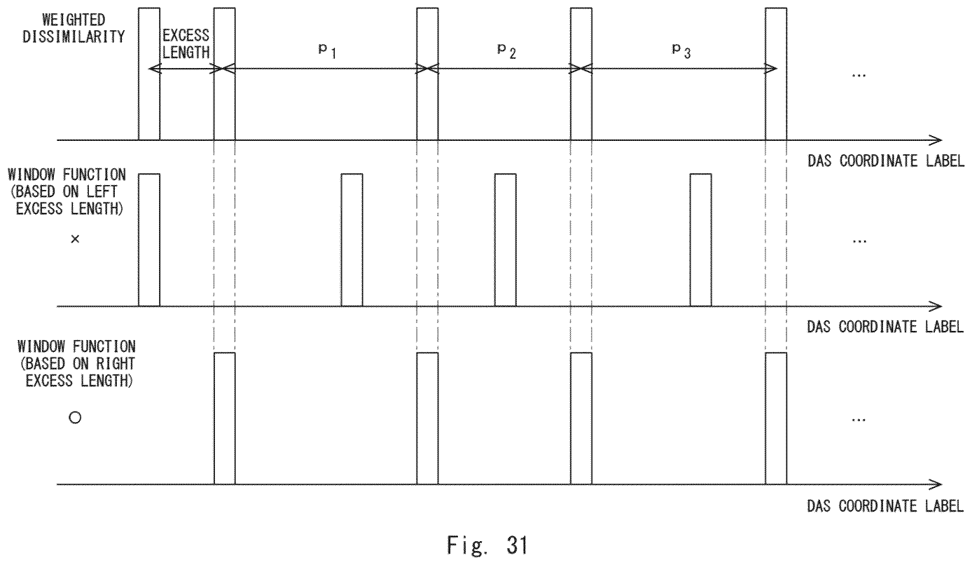

Next, an example of a cross-correlation between the weighted dissimilarity and the window function will be described with reference to FIG. 31.

As described above, the weighted dissimilarity is obtained by weighting the dissimilarity with the frequency average value of the power spectra, and is obtained by multiplying the frequency average value of the power spectra and the dissimilarity.

As illustrated in FIG. 31, in a case where the window function is configured based on the right excess length, the value of the cross-correlation function between the weighted dissimilarity and the window function becomes larger than that in a case where the window function is configured based on the left excess length. Therefore, the pole position calculation unit 44 configures the window function based on the right excess length. Then, the pole position calculation unit 44 searches for a DAS coordinate value (offset point) p_{offset} at which the value of the cross-correlation function has the maximum value. The DAS coordinate value of the offset point corresponds to the position of the right excess length of the optical fiber. Thereafter, the pole position calculation unit 44 estimates the DAS coordinate value of the position of each pole as in the third example embodiment described above.

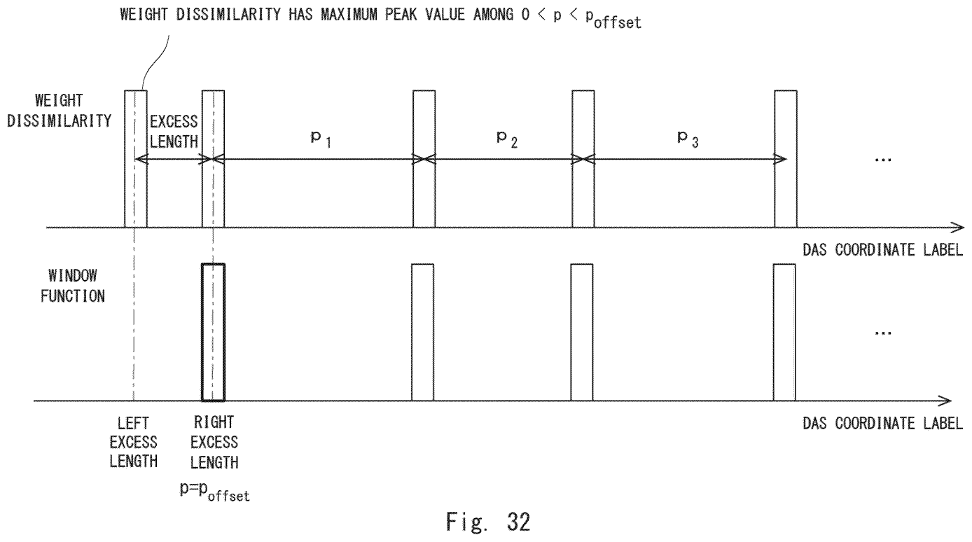

Next, an example of a method of calculating the left excess length by the pole position calculation unit 44 will be described with reference to FIG. 32.

As illustrated in FIG. 32, the pole position calculation unit 44 estimates a DAS coordinate value at which the weighted dissimilarity has the maximum peak value among the DAS coordinate values of the respective positions on a side closer to the DAS than the position of the pole including the excess length section as the DAS coordinate value corresponding to the position of the left excess length of the optical fiber.

As described above, the DAS coordinate value of the offset value p_{offset} corresponds to the position of the right excess length of the optical fiber.

Therefore, in the example of FIG. 32, the pole position calculation unit 44 estimates, as the DAS coordinate value corresponding to the position of the left excess length of the optical fiber, the DAS coordinate value at which the weighted dissimilarity has the maximum value among the DAS coordinate values of 0<p<p_{offset}.

As described above, according to the fourth example embodiment, the vibration characteristic extraction unit 41 inputs the phase difference signal of the backscattered light as the input signal, extracts the input signal in a certain time section, calculates the power spectrum for the extracted input signal, and extracts the power spectrum in a certain frequency band from the calculated power spectrum. The weighted dissimilarity calculation unit 42 calculates the frequency average value of the power spectra at all the DAS coordinate points, calculates the dissimilarity between the two power spectra in the evaluation interval, and calculates the weighted dissimilarity obtained by weighting the dissimilarity with the frequency average value of the power spectra. The excess length section calculation unit 43 sets the excess length section range on the DAS coordinate. The pole position calculation unit 44 determines the analysis target section, and configures the window function in the analysis target section based on the inter-pole distance given in advance. The pole position calculation unit 44 also searches for the DAS coordinate value (offset point) at which the value of the cross-correlation function between the window function and the weighted dissimilarity has the maximum value, adds the inter-pole distance given in advance to the offset point to output the DAS coordinate value corresponding to the position of each pole. The pole position calculation unit 44 outputs the offset point as the DAS coordinate value of the right excess length of the optical fiber. The pole position calculation unit 44 outputs, as the DAS coordinate value of the position of the left excess length of the optical fiber, the DAS coordinate value at which the weighted dissimilarity has the maximum peak value among the DAS coordinate values of the respective positions on a side closer to the DAS than the right excess length. That is, the pole position calculation unit 44 estimates the position of the offset point and the position obtained by adding the inter-pole distance to the offset point as the positions of the respective poles, estimates the position of the offset point as the position of the right excess length, and estimates the position where the weighted dissimilarity has the maximum peak value on a side closer to the DAS than the position of the pole including the excess length section as the position of the left excess length. Then, the pole position calculation unit 44 outputs the DAS coordinate values corresponding to the positions estimated as the position of each pole and the positions of the right excess length and the left excess length.

Therefore, a point at which vibration of the maximum intensity does not occur can also be estimated as the position of each pole or the position of the excess length section of the optical fiber. As a result, it is possible to improve accuracy in estimating the position of each pole or the position of the excess length section of the optical fiber which is an environment change position of the optical fiber. In addition, it is possible to simultaneously estimate the positions of the respective poles.

### Fifth Example Embodiment

A fifth example embodiment corresponds to an example embodiment subordinate to the first to fourth example embodiments described above.

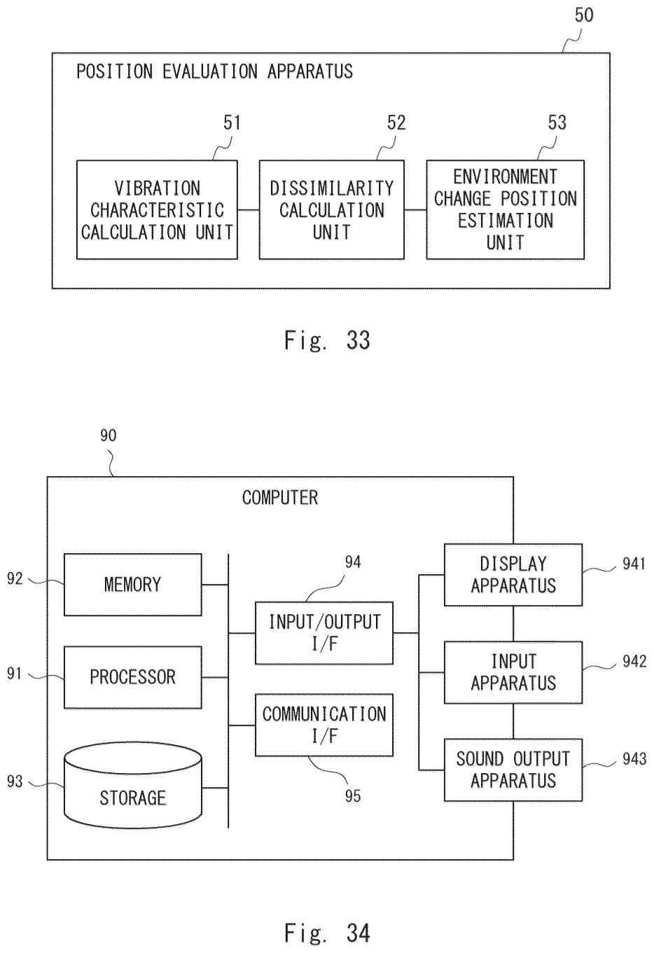

A configuration example of a position evaluation apparatus 50 according to the fifth example embodiment will be described with reference to FIG. 33.

As illustrated in FIG. 33, the position evaluation apparatus 50 according to the fifth example embodiment includes a vibration characteristic calculation unit 51, a dissimilarity calculation unit 52, and an environment change position estimation unit 53.

The vibration characteristic calculation unit 51 inputs a signal indicating natural vibration generated at each position of an optical fiber from a sensor, and calculates sensing data indicating a vibration characteristic at each position of the optical fiber based on the input signal. The vibration characteristic calculation unit 51 corresponds to the vibration characteristic extraction units 11,21,31, and 41 according to the first to fourth example embodiments described above. The sensor corresponds to a phase-sensitive OTDR or DAS.

The dissimilarity calculation unit 52 calculates dissimilarity in sensing data between two adjacent points of the optical fiber. The dissimilarity calculation unit 52 corresponds to the dissimilarity calculation units 12 and 32 according to the first and third example embodiments described above and the weighted dissimilarity calculation units 22 and 42 according to the second and fourth example embodiments described above.

The environment change position estimation unit 53 estimates an environment change position at which an environment of the optical fiber changes based on the dissimilarity. The environment change position estimation unit 53 corresponds to the pole position calculation units 13, 33, and 44 according to the first, third, and fourth example embodiments described above and the excess length section calculation units 23 and 43 according to the second and fourth example embodiments described above.

Since the fifth example embodiment is configured as described above, a point that is not a point at which vibration of the maximum intensity occurs can also be estimated as the environment change position at which the environment of the optical fiber changes. As a result, it is possible to improve accuracy in estimating the environment change position of the optical fiber.

The optical fiber may be an optical fiber suspended on poles.

In this case, the vibration characteristic calculation unit 51 may calculate a power spectrum in a predetermined frequency band as the sensing data. In addition, the dissimilarity calculation unit 52 may calculate dissimilarity in power spectrum between two adjacent points of the optical fiber. Further, the environment change position estimation unit 53 may estimate a position where the dissimilarity has the maximum peak value as a position of the pole on which the optical fiber is suspended.

Alternatively, the vibration characteristic calculation unit 51 may calculate a power spectrum in a predetermined frequency band as the sensing data. In addition, the dissimilarity calculation unit 52 may calculate dissimilarity in power spectrum between two adjacent points of the optical fiber, and calculate weighted dissimilarity obtained by weighting the calculated dissimilarity with a frequency average value of the power spectra. Further, the environment change position estimation unit 53 may set a range in which the frequency average value of the power spectra falls below a threshold as a range of an excess length section of the optical fiber, and then estimate positions where the weighted dissimilarity has the maximum peak value in the range of the excess length section as a left end and a right end of the excess length section.

Alternatively, the vibration characteristic calculation unit 51 may calculate a power spectrum in a predetermined frequency band as the sensing data. In addition, the dissimilarity calculation unit 52 may calculate dissimilarity in power spectrum between two adjacent points of the optical fiber. In addition, the environment change position estimation unit 53 may determine a section including all the poles whose positions are to be estimated as an analysis target section, configure a window function based on an inter-pole distance indicating a distance between adjacent poles given in advance in the analysis target section, search for an offset point at which a correlation function between the window function and the dissimilarity has the maximum value, and estimate a position of the offset point and a position obtained by adding the inter-pole distance to the offset point as the position of the pole on which the optical fiber is suspended.

Alternatively, the vibration characteristic calculation unit 51 may calculate a power spectrum in a predetermined frequency band as the sensing data. In addition, the dissimilarity calculation unit 52 may calculate dissimilarity in power spectrum between two adjacent points of the optical fiber, and calculate weighted dissimilarity obtained by weighting the calculated dissimilarity with a frequency average value of the power spectra. In addition, the environment change position estimation unit 53 may determine a section from a pole including the excess length section of the optical fiber to the next pole including the excess length section as the analysis target section, configure the window function based on the inter-pole distance indicating a distance between adjacent poles given in advance in the analysis target section, search for the offset point at which the correlation function between the window function and the weighted dissimilarity has the maximum value, estimate the position of the offset point and the position obtained by adding the inter-pole distance to the offset point as the position of the pole on which the optical fiber is suspended, and estimate the position of the offset point and a position at which the weighted dissimilarity has a maximum peak value among positions on a side closer to the sensor than the offset point as the left end and the right end of the excess length section.

As described above, in the case of the optical fiber suspended on the poles, the environment change position of the optical fiber estimated in the fifth example embodiment is, for example, the position of the pole on which the optical fiber is suspended and the excess length section of the optical fiber.

However, the environment change position of the optical fiber estimated in the fifth example embodiment is not limited thereto. The fifth example embodiment may be used to estimate, as the environment change position, a position of a boundary point (for example, a fixing point of the optical fiber) where a physical property greatly changes. For example, an optical fiber included in an optical submarine cable has a boundary point between a section embedded in the sea floor and a section exposed to the sea and swung by waves.

The fifth example embodiment may be used to estimate the position of such a boundary point as the environment change position.

### <Hardware Configuration of Position Evaluation Apparatus According to Example Embodiment>

A hardware configuration example of a computer 90 that implements the position evaluation apparatuses 10, 20, 30, 40, and 50 according to the first to fifth example embodiments described above will be described with reference to FIG. 34.

As illustrated in FIG. 34, the computer 90 includes a processor 91, a memory 92, a storage 93, an input/output interface (input/output I/F) 94, a communication interface (communication I/F) 95, and the like. The processor 91, the memory 92, the storage 93, the input/output interface 94, and the communication interface 95 are connected by a data transmission line for mutually transmitting or receiving data.

The processor 91 is an arithmetic processing apparatus such as a central processing unit (CPU) or a graphics processing unit (GPU). The memory 92 is a memory such as a random access memory (RAM) or a read only memory (ROM).

The storage 93 is, for example, a storage device such as a hard disk drive (HDD), a solid state drive (SSD), or a memory card. Furthermore, the storage 93 may be a memory such as a RAM or a ROM.

A program is stored in the storage 93. This program includes a group of commands (or software code) for causing the computer 90 to execute one or more functions in the above-described position evaluation apparatuses 10, 20, 30, 40, and 50 in a case where read by the computer. The components in the position evaluation apparatuses 10, 20, 30, 40, and 50 described above may be implemented by the processor 91 reading and executing the program stored in the storage 93. In addition, a storage function in the position evaluation apparatuses 10, 20, 30, 40, and 50 described above may be implemented by the memory 92 or the storage 93.

Further, the above-described program may be stored in a non-transitory computer-readable medium or a tangible storage medium. As an example and not by way of limitation, the computer-readable medium or the tangible storage medium includes a RAM, a ROM, a flash memory, an SSD or other memory technology, a compact disc (CD)-ROM, a digital versatile disc (DVD), a Blu-ray (registered trademark) disk or other optical disk storages, a magnetic cassette, a magnetic tape, a magnetic disk storage, or other magnetic storage devices. The program may be transmitted on a transitory computer-readable medium or a communication medium. As an example and not by way of limitation, transitory computer-readable or communication media include electrical, optical, acoustic, or other forms of propagated signals.

The input/output interface 94 is connected to a display apparatus 941, an input apparatus 942, a sound output apparatus 943, or the like. The display apparatus 941 is an apparatus that displays a screen corresponding to depiction data processed by the processor 91, such as a liquid crystal display (LCD), a cathode ray tube (CRT) display, or a monitor. The input apparatus 942 is an apparatus that receives an input of an operation performed by an operator, and is, for example, a keyboard, a mouse, or a touch sensor. The display apparatus 941 and the input apparatus 942 may be integrated, and may be implemented as a touch panel. The sound output apparatus 943 is an apparatus that acoustically outputs sound that corresponds to acoustic data that has been processed by the processor 91 such as a speaker.

The communication interface 95 transmits or receives data to and from an external apparatus. For example, the communication interface 95 communicates with an external apparatus via a wired communication path or a wireless communication path.

The present disclosure has been described above with reference to the example embodiments, but the present disclosure is not limited to the example embodiments described above. Various modifications that can be understood by those skilled in the art can be made to the configurations and details of the present disclosure within the scope of the present disclosure. For example, some or all of the above-described example embodiments may be used in combination with one another.

In addition, some or all of the above-described example embodiments may be described in supplementary notes below, but are not limited thereto.

### (Supplementary Note 1)

A position evaluation apparatus including:
a vibration characteristic calculation unit configured to input a signal indicating natural vibration occurring at each position of an optical fiber from a sensor and calculate sensing data indicating a vibration characteristic at each position of the optical fiber based on the input signal;
a dissimilarity calculation unit configured to calculate dissimilarity in the sensing data between two adjacent points of the optical fiber; and
an environment change position estimation unit configured to estimate an environment change position where an environment of the optical fiber changes based on the dissimilarity.

### (Supplementary Note 2)

The position evaluation apparatus according to Supplementary Note 1, in which
the optical fiber is an optical fiber suspended on poles,
the vibration characteristic calculation unit calculates, as the sensing data, a power spectrum in a predetermined frequency band,
the dissimilarity calculation unit calculates dissimilarity in the power spectrum between two adjacent points of the optical fiber, and
the environment change position estimation unit estimates a position at which the dissimilarity has a maximum peak value as a position of the pole on which the optical fiber is suspended.

### (Supplementary Note 3)

The position evaluation apparatus according to Supplementary Note 1, in which
the optical fiber is an optical fiber suspended on poles,
the vibration characteristic calculation unit calculates, as the sensing data, a power spectrum in a predetermined frequency band,
the dissimilarity calculation unit calculates dissimilarity in the power spectrum between two adjacent points of the optical fiber and calculates weighted dissimilarity obtained by weighting the calculated dissimilarity with a frequency average value of the power spectra, and
the environment change position estimation unit sets, as a range of an excess length section of the optical fiber, a range in which the frequency average value of the power spectra falls below a threshold, and then estimates positions where the weighted dissimilarity has a maximum peak value in the range of the excess length section as a left end and a right end of the excess length section.

### (Supplementary Note 4)

The position evaluation apparatus according to Supplementary Note 1, in which
the optical fiber is an optical fiber suspended on poles,
the vibration characteristic calculation unit calculates, as the sensing data, a power spectrum in a predetermined frequency band,
the dissimilarity calculation unit calculates dissimilarity in the power spectrum between two adjacent points of the optical fiber, and
the environment change position estimation unit
determines a section including all the poles whose positions are to be estimated as an analysis target section,
configures a window function based on an inter-pole distance indicating a distance between adjacent poles given in advance in the analysis target section,
searches for an offset point at which a correlation function between the window function and the dissimilarity has a maximum value in the analysis target section, and
estimates a position of the offset point and a position obtained by adding the inter-pole distance to the offset point in the analysis target section as the positions of the poles on which the optical fiber is suspended.

### (Supplementary Note 5)

The position evaluation apparatus according to Supplementary Note 1, in which
the optical fiber is an optical fiber suspended on poles,
the vibration characteristic calculation unit calculates, as the sensing data, a power spectrum in a predetermined frequency band,
the dissimilarity calculation unit calculates dissimilarity in the power spectrum between two adjacent points of the optical fiber and calculates weighted dissimilarity obtained by weighting the calculated dissimilarity with a frequency average value of the power spectra, and
the environment change position estimation unit
determines, as an analysis target section, a section from a pole including an excess length section of the optical fiber to a next pole including the excess length section,
configures a window function based on an inter-pole distance indicating a distance between adjacent poles given in advance in the analysis target section,
searches for an offset point at which a correlation function between the window function and the weighted dissimilarity has a maximum value in the analysis target section,
estimates a position of the offset point and a position obtained by adding the inter-pole distance to the offset point in the analysis target section as positions of the poles on which the optical fiber is suspended, and
estimates the position of the offset point and a position where the weighted dissimilarity has a maximum peak value among positions closer to the sensor than the offset point in the analysis target section as a left end and a right end of the excess length section.

### (Supplementary Note 6)

The position evaluation apparatus according to any one of Supplementary Notes 2 to 5, in which the predetermined frequency band is a frequency band including a basic vibration mode in a suspension section of the optical fiber.

### (Supplementary Note 7)

A position evaluation method executed by a position evaluation apparatus, the position evaluation method including:
a vibration characteristic calculation step of inputting a signal indicating natural vibration occurring at each position of an optical fiber from a sensor and calculating sensing data indicating a vibration characteristic at each position of the optical fiber based on the input signal;
a dissimilarity calculation step of calculating dissimilarity in the sensing data between two adjacent points of the optical fiber; and
an environment change position estimation step of estimating an environment change position where an environment of the optical fiber changes based on the dissimilarity.

### (Supplementary Note 8)

The position evaluation method according to Supplementary Note 7, in which
the optical fiber is an optical fiber suspended on poles,
in the vibration characteristic calculation step, a power spectrum in a predetermined frequency band is calculated as the sensing data,
in the dissimilarity calculation step, dissimilarity in the power spectrum between two adjacent points of the optical fiber is calculated, and
in the environment change position estimation step, a position at which the dissimilarity has a maximum peak value is estimated as a position of the pole on which the optical fiber is suspended.

### (Supplementary Note 9)

The position evaluation method according to Supplementary Note 7, in which
the optical fiber is an optical fiber suspended on poles,
in the vibration characteristic calculation step, a power spectrum in a predetermined frequency band is calculated as the sensing data,
in the dissimilarity calculation step, dissimilarity in the power spectrum between two adjacent points of the optical fiber is calculated and weighted dissimilarity obtained by weighting the calculated dissimilarity with a frequency average value of the power spectra is calculated, and
in the environment change position estimation step, a range in which the frequency average value of the power spectra falls below a threshold is set as a range of an excess length section of the optical fiber, and then positions where the weighted dissimilarity has a maximum peak value in the range of the excess length section are estimated as a left end and a right end of the excess length section.

### (Supplementary Note 10)

The position evaluation method according to Supplementary Note 7, in which
the optical fiber is an optical fiber suspended on poles,
in the vibration characteristic calculation step, a power spectrum in a predetermined frequency band is calculated as the sensing data,
in the dissimilarity calculation step, dissimilarity in the power spectrum between two adjacent points of the optical fiber is calculated, and
in the environment change position estimation step,
a section including all the poles whose positions are to be estimated is determined as an analysis target section,
a window function is configured based on an inter-pole distance indicating a distance between adjacent poles given in advance in the analysis target section,
an offset point at which a correlation function between the window function and the dissimilarity has a maximum value is searched for in the analysis target section, and
a position of the offset point and a position obtained by adding the inter-pole distance to the offset point in the analysis target section are estimated as the positions of the poles on which the optical fiber is suspended.

### (Supplementary Note 11)

The position evaluation method according to Supplementary Note 7, in which
the optical fiber is an optical fiber suspended on poles,
in the vibration characteristic calculation step, a power spectrum in a predetermined frequency band is calculated as the sensing data,
in the dissimilarity calculation step, dissimilarity in the power spectrum between two adjacent points of the optical fiber is calculated and weighted dissimilarity obtained by weighting the calculated dissimilarity with a frequency average value of the power spectra is calculated, and
in the environment change position estimation step,
a section from a pole including an excess length section of the optical fiber to a next pole including the excess length section is determined as an analysis target section,
a window function is configured based on an inter-pole distance indicating a distance between adjacent poles given in advance in the analysis target section,
an offset point at which a correlation function between the window function and the weighted dissimilarity has a maximum value is searched for in the analysis target section,
a position of the offset point and a position obtained by adding the inter-pole distance to the offset point in the analysis target section are estimated as positions of the poles on which the optical fiber is suspended, and
the position of the offset point and a position where the weighted dissimilarity has a maximum peak value among positions closer to the sensor than the offset point in the analysis target section are estimated as a left end and a right end of the excess length section.

### (Supplementary Note 12)

The position evaluation method according to any one of Supplementary Notes 8 to 11, in which the predetermined frequency band is a frequency band including a basic vibration mode in a suspension section of the optical fiber.

### (Supplementary Note 13)

A non-transitory computer-readable medium storing a program for causing a computer to execute:
a vibration characteristic calculation step of inputting a signal indicating natural vibration occurring at each position of an optical fiber from a sensor and calculating sensing data indicating a vibration characteristic at each position of the optical fiber based on the input signal;
a dissimilarity calculation step of calculating dissimilarity in the sensing data between two adjacent points of the optical fiber; and
an environment change position estimation step of estimating an environment change position where an environment of the optical fiber changes based on the dissimilarity.

### (Supplementary Note 14)

The computer-readable medium according to Supplementary Note 13, in which
the optical fiber is an optical fiber suspended on poles,
in the vibration characteristic calculation step, a power spectrum in a predetermined frequency band is calculated as the sensing data,
in the dissimilarity calculation step, dissimilarity in the power spectrum between two adjacent points of the optical fiber is calculated, and
in the environment change position estimation step, a position at which the dissimilarity has a maximum peak value is estimated as a position of the pole on which the optical fiber is suspended.

### (Supplementary Note 15)

The computer-readable medium according to Supplementary Note 13, in which
the optical fiber is an optical fiber suspended on poles,
in the vibration characteristic calculation step, a power spectrum in a predetermined frequency band is calculated as the sensing data,
in the dissimilarity calculation step, dissimilarity in the power spectrum between two adjacent points of the optical fiber is calculated and weighted dissimilarity obtained by weighting the calculated dissimilarity with a frequency average value of the power spectra is calculated, and
in the environment change position estimation step, a range in which the frequency average value of the power spectra falls below a threshold is set as a range of an excess length section of the optical fiber, and then positions where the weighted dissimilarity has a maximum peak value in the range of the excess length section are estimated as a left end and a right end of the excess length section.

### (Supplementary Note 16)

The computer-readable medium according to Supplementary Note 13, in which
the optical fiber is an optical fiber suspended on poles,
in the vibration characteristic calculation step, a power spectrum in a predetermined frequency band is calculated as the sensing data,
in the dissimilarity calculation step, dissimilarity in the power spectrum between two adjacent points of the optical fiber is calculated, and
in the environment change position estimation step,
a section including all the poles whose positions are to be estimated is determined as an analysis target section,
a window function is configured based on an inter-pole distance indicating a distance between adjacent poles given in advance in the analysis target section,
an offset point at which a correlation function between the window function and the dissimilarity has a maximum value is searched for in the analysis target section, and
a position of the offset point and a position obtained by adding the inter-pole distance to the offset point in the analysis target section are estimated as the positions of the poles on which the optical fiber is suspended.

### (Supplementary Note 17)

The computer-readable medium according to Supplementary Note 13, in which
the optical fiber is an optical fiber suspended on poles,
in the vibration characteristic calculation step, a power spectrum in a predetermined frequency band is calculated as the sensing data,
in the dissimilarity calculation step, dissimilarity in the power spectrum between two adjacent points of the optical fiber is calculated and weighted dissimilarity obtained by weighting the calculated dissimilarity with a frequency average value of the power spectra is calculated, and
in the environment change position estimation step,
a section from a pole including an excess length section of the optical fiber to a next pole including the excess length section is determined as an analysis target section,
a window function is configured based on an inter-pole distance indicating a distance between adjacent poles given in advance in the analysis target section, an offset point at which a correlation function between the window function and the weighted dissimilarity has a maximum value is searched for in the analysis target section,
a position of the offset point and a position obtained by adding the inter-pole distance to the offset point in the analysis target section are estimated as positions of the poles on which the optical fiber is suspended, and
the position of the offset point and a position where the weighted dissimilarity has a maximum peak value among positions closer to the sensor than the offset point in the analysis target section are estimated as a left end and a right end of the excess length section.

### (Supplementary Note 18)

The computer-readable medium according to any one of Supplementary Notes 14 to 17, in which the predetermined frequency band is a frequency band including a basic vibration mode in a suspension section of the optical fiber.

### REFERENCE SIGNS LIST

10, 20, 30, 40, 50 POSITION EVALUATION APPARATUS
11, 21, 31, 41 VIBRATION CHARACTERISTIC EXTRACTION UNIT
12, 32, 52 DISSIMILARITY CALCULATION UNIT
13, 33, 44 POLE POSITION CALCULATION UNIT
22, 42 WEIGHTED DISSIMILARITY CALCULATION UNIT
23, 43 EXCESS LENGTH SECTION CALCULATION UNIT
51 VIBRATION CHARACTERISTIC CALCULATION UNIT
53 ENVIRONMENT CHANGE POSITION ESTIMATION UNIT
90 COMPUTER
91 PROCESSOR
92 MEMORY
93 STORAGE
94 INPUT/OUTPUT INTERFACE
941 DISPLAY APPARATUS
942 INPUT APPARATUS
943 SOUND OUTPUT APPARATUS
95 COMMUNICATION INTERFACE

What is claimed is:

1. A position evaluation apparatus comprising:
at least one memory storing instructions, and
at least one processor configured to execute the instructions to;
input a signal indicating natural vibration occurring at each position of an optical fiber from a sensor and calculate sensing data indicating a vibration characteristic at each position of the optical fiber based on the input signal;
calculate dissimilarity in the sensing data between two adjacent points of the optical fiber; and
estimate an environment change position where an environment of the optical fiber changes based on the dissimilarity.

2. The position evaluation apparatus according to claim 1, wherein
the optical fiber is an optical fiber suspended on poles,
the at least one processor is further configured to execute the instructions to calculate, as the sensing data, a power spectrum in a predetermined frequency band,
calculate dissimilarity in the power spectrum between two adjacent points of the optical fiber, and
estimate a position at which the dissimilarity has a maximum peak value as a position of the pole on which the optical fiber is suspended.

3. The position evaluation apparatus according to claim 1, wherein
the optical fiber is an optical fiber suspended on poles,
the at least one processor is further configured to execute the instructions to calculate, as the sensing data, a power spectrum in a predetermined frequency band,
calculate dissimilarity in the power spectrum between two adjacent points of the optical fiber and calculate weighted dissimilarity obtained by weighting the calculated dissimilarity with a frequency average value of the power spectra, and
set, as a range of an excess length section of the optical fiber, a range in which the frequency average value of the power spectra falls below a threshold, and then estimate positions where the weighted dissimilarity has a maximum peak value in the range of the excess length section as a left end and a right end of the excess length section.

4. The position evaluation apparatus according to claim 1, wherein
the optical fiber is an optical fiber suspended on poles,
the at least one processor is further configured to execute the instructions to calculate, as the sensing data, a power spectrum in a predetermined frequency band,
calculate dissimilarity in the power spectrum between two adjacent points of the optical fiber, and
determine a section including all the poles whose positions are to be estimated as an analysis target section,
configure a window function based on an inter-pole distance indicating a distance between adjacent poles given in advance in the analysis target section,
search for an offset point at which a correlation function between the window function and the dissimilarity has a maximum value in the analysis target section, and
estimate a position of the offset point and a position obtained by adding the inter-pole distance to the offset point in the analysis target section as the positions of the poles on which the optical fiber is suspended.

5. The position evaluation apparatus according to claim 1, wherein
the optical fiber is an optical fiber suspended on poles,
the at least one processor is further configured to execute the instructions to
calculate, as the sensing data, a power spectrum in a predetermined frequency band,
calculate dissimilarity in the power spectrum between two adjacent points of the optical fiber and calculate weighted dissimilarity obtained by weighting the calculated dissimilarity with a frequency average value of the power spectra, and
determine, as an analysis target section, a section from a pole including an excess length section of the optical fiber to a next pole including the excess length section,
configure a window function based on an inter-pole distance indicating a distance between adjacent poles given in advance in the analysis target section,
search for an offset point at which a correlation function between the window function and the weighted dissimilarity has a maximum value in the analysis target section,
estimate a position of the offset point and a position obtained by adding the inter-pole distance to the offset point in the analysis target section as positions of the poles on which the optical fiber is suspended, and
estimate the position of the offset point and a position where the weighted dissimilarity has a maximum peak value among positions closer to the sensor than the offset point in the analysis target section as a left end and a right end of the excess length section.

6. The position evaluation apparatus according to claim 2, wherein the predetermined frequency band is a frequency band including a basic vibration mode in a suspension section of the optical fiber.

7. A position evaluation method executed by a position evaluation apparatus, the position evaluation method comprising:
a vibration characteristic calculation step of inputting a signal indicating natural vibration occurring at each position of an optical fiber from a sensor and calculating sensing data indicating a vibration characteristic at each position of the optical fiber based on the input signal;
a dissimilarity calculation step of calculating dissimilarity in the sensing data between two adjacent points of the optical fiber; and
an environment change position estimation step of estimating an environment change position where an environment of the optical fiber changes based on the dissimilarity.

8. The position evaluation method according to claim 7, wherein
the optical fiber is an optical fiber suspended on poles,
in the vibration characteristic calculation step, a power spectrum in a predetermined frequency band is calculated as the sensing data,
in the dissimilarity calculation step, dissimilarity in the power spectrum between two adjacent points of the optical fiber is calculated, and
in the environment change position estimation step, a position at which the dissimilarity has a maximum peak value is estimated as a position of the pole on which the optical fiber is suspended.

9. The position evaluation method according to claim 7, wherein
the optical fiber is an optical fiber suspended on poles,
in the vibration characteristic calculation step, a power spectrum in a predetermined frequency band is calculated as the sensing data,
in the dissimilarity calculation step, dissimilarity in the power spectrum between two adjacent points of the optical fiber is calculated and weighted dissimilarity obtained by weighting the calculated dissimilarity with a frequency average value of the power spectra is calculated, and
in the environment change position estimation step, a range in which the frequency average value of the power spectra falls below a threshold is set as a range of an excess length section of the optical fiber, and then positions where the weighted dissimilarity has a maximum peak value in the range of the excess length section are estimated as a left end and a right end of the excess length section.

10. The position evaluation method according to claim 7, wherein
the optical fiber is an optical fiber suspended on poles,
in the vibration characteristic calculation step, a power spectrum in a predetermined frequency band is calculated as the sensing data,
in the dissimilarity calculation step, dissimilarity in the power spectrum between two adjacent points of the optical fiber is calculated, and
in the environment change position estimation step,
a section including all the poles whose positions are to be estimated is determined as an analysis target section,
a window function is configured based on an inter-pole distance indicating a distance between adjacent poles given in advance in the analysis target section,
an offset point at which a correlation function between the window function and the dissimilarity has a maximum value is searched for in the analysis target section, and
a position of the offset point and a position obtained by adding the inter-pole distance to the offset point in the analysis target section are estimated as the positions of the poles on which the optical fiber is suspended.

11. The position evaluation method according to claim 7, wherein
the optical fiber is an optical fiber suspended on poles,
in the vibration characteristic calculation step, a power spectrum in a predetermined frequency band is calculated as the sensing data,
in the dissimilarity calculation step, dissimilarity in the power spectrum between two adjacent points of the optical fiber is calculated and weighted dissimilarity obtained by weighting the calculated dissimilarity with a frequency average value of the power spectra is calculated, and
in the environment change position estimation step,
a section from a pole including an excess length section of the optical fiber to a next pole including the excess length section is determined as an analysis target section,
a window function is configured based on an inter-pole distance indicating a distance between adjacent poles given in advance in the analysis target section,
an offset point at which a correlation function between the window function and the weighted dissimilarity has a maximum value is searched for in the analysis target section,
a position of the offset point and a position obtained by adding the inter-pole distance to the offset point in the analysis target section are estimated as positions of the poles on which the optical fiber is suspended, and
the position of the offset point and a position where the weighted dissimilarity has a maximum peak value among positions closer to the sensor than the offset point in the analysis target section are estimated as a left end and a right end of the excess length section.

12. The position evaluation method according to claim 8, wherein the predetermined frequency band is a frequency band including a basic vibration mode in a suspension section of the optical fiber.

13. A non-transitory computer-readable medium storing a program for causing a computer to execute:
a vibration characteristic calculation step of inputting a signal indicating natural vibration occurring at each position of an optical fiber from a sensor and calculating sensing data indicating a vibration characteristic at each position of the optical fiber based on the input signal;
a dissimilarity calculation step of calculating dissimilarity in the sensing data between two adjacent points of the optical fiber; and
an environment change position estimation step of estimating an environment change position where an environment of the optical fiber changes based on the dissimilarity.

14. The computer-readable medium according to claim 13, wherein
the optical fiber is an optical fiber suspended on poles,
in the vibration characteristic calculation step, a power spectrum in a predetermined frequency band is calculated as the sensing data,
in the dissimilarity calculation step, dissimilarity in the power spectrum between two adjacent points of the optical fiber is calculated, and
in the environment change position estimation step, a position at which the dissimilarity has a maximum peak value is estimated as a position of the pole on which the optical fiber is suspended.

15. The computer-readable medium according to claim 13, wherein
the optical fiber is an optical fiber suspended on poles,
in the vibration characteristic calculation step, a power spectrum in a predetermined frequency band is calculated as the sensing data,
in the dissimilarity calculation step, dissimilarity in the power spectrum between two adjacent points of the optical fiber is calculated and weighted dissimilarity obtained by weighting the calculated dissimilarity with a frequency average value of the power spectra is calculated, and
in the environment change position estimation step, a range in which the frequency average value of the power spectra falls below a threshold is set as a range of an excess length section of the optical fiber, and then positions where the weighted dissimilarity has a maximum peak value in the range of the excess length section are estimated as a left end and a right end of the excess length section.

16. The computer-readable medium according to claim 13, wherein
the optical fiber is an optical fiber suspended on poles,
in the vibration characteristic calculation step, a power spectrum in a predetermined frequency band is calculated as the sensing data,
in the dissimilarity calculation step, dissimilarity in the power spectrum between two adjacent points of the optical fiber is calculated, and
in the environment change position estimation step,
a section including all the poles whose positions are to be estimated is determined as an analysis target section,
a window function is configured based on an inter-pole distance indicating a distance between adjacent poles given in advance in the analysis target section,
an offset point at which a correlation function between the window function and the dissimilarity has a maximum value is searched for in the analysis target section, and
a position of the offset point and a position obtained by adding the inter-pole distance to the offset point in the analysis target section are estimated as the positions of the poles on which the optical fiber is suspended.

17. The computer-readable medium according to claim 13, wherein
the optical fiber is an optical fiber suspended on poles,
in the vibration characteristic calculation step, a power spectrum in a predetermined frequency band is calculated as the sensing data,
in the dissimilarity calculation step, dissimilarity in the power spectrum between two adjacent points of the optical fiber is calculated and weighted dissimilarity obtained by weighting the calculated dissimilarity with a frequency average value of the power spectra is calculated, and
in the environment change position estimation step,
a section from a pole including an excess length section of the optical fiber to a next pole including the excess length section is determined as an analysis target section,
a window function is configured based on an inter-pole distance indicating a distance between adjacent poles given in advance in the analysis target section,
an offset point at which a correlation function between the window function and the weighted dissimilarity has a maximum value is searched for in the analysis target section,
a position of the offset point and a position obtained by adding the inter-pole distance to the offset point in the analysis target section are estimated as positions of the poles on which the optical fiber is suspended, and
the position of the offset point and a position where the weighted dissimilarity has a maximum peak value among positions closer to the sensor than the offset point in the analysis target section are estimated as a left end and a right end of the excess length section.

18. The computer-readable medium according to claim 14, wherein the predetermined frequency band is a frequency band including a basic vibration mode in a suspension section of the optical fiber.
